(19) United States
(12) Patent Application Publication
(10) Pub. No.: US 2011/0225198 A1
(43) Pub. Date: Sep. 15, 2011

(54) System and Methods for Linking Multiple Events Involving Firearms and Gang Related Activities

(76) Inventors: Rocky L. Edwards, Corona, CA (US); Jon Centanni, Yorba Linda, CA (US)

(21) Appl. No.: 13/115,073

(22) Filed: May 24, 2011

Related U.S. Application Data
(63) Continuation of application No. 12/085,249, filed on Nov. 3, 2008.
Application No. 12/085,249 is a continuation-in-part of application No. 11/284,534, filed on Nov. 21, 2005, now abandoned.

(51) Int. Cl. G06F 17/30

(52) U.S. Cl. 707/780; 707/E17.014

(57) ABSTRACT

Methods for linking multiple events involving firearms submit event information data and firearms information data to a system that includes a database for multiple firearms events and generate a query map that correlates data in the system database with a preselected geographical grid based upon one or more preselected matching criteria to one or more data entries for a selected event. The map is used to generate a request for a possible link analysis which may be initiated by a firearms examiner and is then performed to determine if there is a link. The event information data can include a case number, a geographical location data entry, a date entry, a crime type, a weapon involved and a suspect information data field based upon input from an investigating officer while the firearms information data can include a weapon data entry and a bullet data entry based upon input from a person with firearms examiner training. The methodology can be used to prioritize multiple requests for a possible link analysis based upon information obtained in one or more query responses and the query response can display at least some of its information in a query map that correlates data in the system database with a preselected geographical grid. One or more gang database modules allow users to execute searches of a gang database and plot incidents on a geographic grid with each incident being represented by a unique icon related to a class of crime or type of incident.

### CROSS REFERENCE TO RELATED APPLICATIONS

The present invention is a continuation of U.S. patent application Ser. No. 12/085,249 filed Nov. 3, 2008 which is a 371 of PCT/US2006/044523 filed Nov. 20, 2006, which itself was a continuation-in-part application of U.S. patent application Ser. No. 11/284,534, filed Nov. 21, 2005, the disclosures of all of which are specifically incorporated herein by reference.

### FIELD OF THE INVENTION

The present invention is in the field of systems and methods for linking multiple events involving firearms and also for correlating links between multiple events involving firearms to criminal investigation and prosecution through one or more databases relating to gang activity.

### BACKGROUND OF THE INVENTION

Present society throughout the United States, and elsewhere in certain parts of the world, has come to witness widespread firearm related incidents due to terrorist and criminal activity. For example, cities across the United States are having a serious gang activity problem and consequently, numerous firearm related incidents. As a result, firearms units across the United States have large backlogs of firearms that need to be processed as well as evidence cartridge cases and bullets that need to processed. And, because crime labs usually have limited resources, they are stretched to the limit.

Current practices in most cities in the United States dictate reactive law enforcement. That is city resources determine how law enforcement for a community reacts to crimes in their area of jurisdiction. When a serious crime occurs (homicide, attempted homicide, etc.) police officers typically respond to the initial incident, secure the crime scene, render assistance to the victims and identify potential witnesses and suspects. Crime scene investigators (CSI) respond to document the crime scene through sketches and descriptions of the crime scene, as well as 360-degree photography of the entire scene. During serious incidents such as a homicide, kidnapping or rape, detectives are assigned to investigate the case right away. Less serious crimes and gang related crimes such as drive by shootings in which a home or car is hit or the target of the shooting was not seriously wounded are handled in a different manner. A detective is not assigned the case right away, if ever, and these cases often times fall by the wayside. This is largely due to limited resources, lack of personnel and insufficient funding. Days, months and possibly years will pass (sometimes past the statute of limitations) before these cases get followed up. There are even times when the evidence will be destroyed by the evidence room before it is ever examined. Experience teaches that the perpetrators of minor shootings incidents eventually gravitate to murder.

Forensic Firearms Examiners at about 275 sites around the United States utilize a computer system, which is part of the National Ballistic Information Network. This enables technicians to digitally enter test fire crime scene cartridge cases and bullets that are submitted by detectives and CSI. This evidence results from arrests, crime scene searches and search warrants. The main function of the NIBIN (National Integrated Ballistic Identification Network) network is to link crimes to previously unknown related crimes or crimes to previously unknown related firearms. The NIBIN system works; however, it has limitations. The system is an image-based system in which only examiners and technicians have access. No information is entered into the system which is relevant to the crime itself except date of occurrence and other basic information that is not accessible to the detectives investigating the incident.

Today's Detectives (in most cities) submit a request for firearms examinations to the crime lab for entry into NIBIN. No real prioritization of the requests exists for many crime laboratories. When a request comes in to the lab it is put in line with all of the other cases and may take months or sometimes years before any forensic work is completed. Smaller police departments do not have NIBIN systems and will never have these systems. The NIBIN computer systems are only available to large crime labs around the United States with a firearms examiner. These labs were provided the NIBIN systems through Congressional funding. Funding is not available, however, for systems to be placed in smaller police departments. Currently there are no systems available to smaller departments unless they purchase their own NIBIN system.

This state of present affairs has created a number of problems. Detectives and forensic personnel have no way of actively communicating with each other on a regular basis and important criminal intelligence is lost because of this lack of communication. There are no ways to visually track crimes as they occur in the city as they are documented by Crime Scene Investigations (CSI). Many minor cases fall through the cracks and are never requested for examination and subsequently never entered into the NIBIN system. There is insufficient prioritization of cases. Communication between the crime lab, detectives and patrol is lacking. Detectives must many times fill out a lengthy lab request in order to have the lab conduct the examination. There is no screening process for requests in most departments. Smaller departments have no NIBIN system and have no way of tracking firearm related incidents; they are at the mercy of larger labs that support the surrounding community and, subsequently, their requests are put in order with other department's requests. Larger higher producing labs which have many NIBIN hits have problems managing the information (criminal intelligence) that is gathered as a result of linking cases to each other that were not previously known to be linked; there is no central data point for information gathered as a result of NIBIN links. Reports writing of cold case links are time consuming. There is no way of screening what cases are sent to the crime lab for examination. There is no visual or class characteristic screening of bullets or cartridge cases to determine if they may be related. The NIBIN systems are too expensive for use by smaller police departments if not funded through grants and departments must have a firearms examiner to obtain a NIBIN system (IBIS—Integrated Ballistic Identification System).

Accordingly, there is a very real and long-felt need for improvement, especially since these problems affect public safety and the ability of law enforcement agencies to carry out their job. The present invention addresses all of these issues and provides solutions to the above listed problems. As such the present invention provides a critical tool for aiding law enforcement in doing its job and, as will be discussed in the detailed description of the invention, the results can be dramatic.

It is significant to note that there is over 17,000 Police Departments in the United States and over 3100 Sheriffs Offices, most of which can benefit from the present invention. Moreover, Federal and State Agencies can also use this invention. For example, agencies such as Bureau of Land Management can use this invention to assist game wardens tracking the movements and locations of poachers. In addition, there are over 60 countries in the world that could use this invention as well. This invention can be used by any of these departments to combat firearm related crimes.

Accordingly, there is an overwhelming need for this invention and its potential is almost unlimited, especially since it can be used anywhere in world under any type of conditions. Military use of this invention is also a possibility in regions where insurgency tracking through the use of firearms and the movements of people using those firearms is important.

Once the systems and methods for linking multiple events involving firearms according to the present invention are put in use, there should be a marked increase in detected linkages between multiple events involving firearms. This is where the additional inventions disclosed in the present invention, as compared to what is disclosed in our prior invention, U.S. Ser. No. 11/284,534, take over.

While it is true that unlinked multiple events involving firearms remain unconnected (by definition), it is not always true, and often may not be true, that simply linking multiple events involving firearms will lead to solving crimes or successful prosecution of such crimes. If a police department or other investigative agency has a high number of linkages, the linkage of previous unlinked events may simply be treated as one more piece of information available to overworked detectives and investigators, and it may be overlooked or not fully utilized in a timely fashion. It is to this problem that the additional inventions disclosed in this invention are directed.

### SUMMARY OF THE INVENTION

The present invention is generally directed to a method for linking multiple events involving firearms by submitting event information data and firearms information data to a system database for multiple firearms events and generating a query map that correlates data in the system database with a preselected geographical grid based upon one or more preselected matching criteria to one or more data entries for a selected event.

In a first, separate group of aspects of the present invention, a query map is used to generate a request (that may automatically contain some information from the system database) for a possible link analysis (e.g., a NIBIN analysis) which may be initiated by a firearms examiner and is then performed to determine if there is a link. The event information data can include a case number, a geographical location data entry, a date entry, a crime type, a weapon involved and a suspect information data field based upon input from an investigating officer while the firearms information data can include a weapon data entry (such as a weapon type and caliber) and a bullet data entry (such as a lands and grooves entry, a direction of twist entry, a lands measurement and a grooves measurement) based upon input from a person with firearms examiner training.

In a second, separate group of aspects of the present invention, a system database is created for different events which is periodically updated with data for new events that contains applicable event information data at least partially based upon input from an investigating officer (which may at least partially be done during investigation of the new event) and applicable firearms information data at least partially based upon input from a person with firearms examiner training, a permitted user is allowed to generate a query response that correlates data from the system database based upon a chosen matching criteria that can be varied by the permitted user, a request is made for a possible link analysis of two or more unlinked events based upon information obtained from the query response and then the possible link analysis is performed to determine if there is a link. Such methodology can be used to prioritize multiple requests for a possible link analysis based upon information obtained in one or more query responses and the query response can display at least some of its information in a query map that correlates data in the system database with a preselected geographical grid.

In a third, separate group of aspects of the present invention, a system for assisting analysis and correlation of multiple events involving firearms utilizes a database for storing event information data and firearms examination information data that are correlated to a single event involving a firearm, an investigating officer input mechanism for adding applicable event information data at least partially based upon input from an investigating officer for a plurality of events to the database, a firearms examiner input mechanism for adding firearms information data at least partially based upon input from a person with firearms examiner training and a mapping component for allowing a user of the system to generate a query map that correlates data in the database with a preselected geographic grid based upon one or more preselected matching criteria and at least one data entry for a selected event. The system can also include report generating components to generate reports based at least in part upon firearms examination information in the database.

In a fourth, separate group of aspects of the present invention, one or more Gang Database Modules access a plurality of data fields within a Gang Database to allow a user to execute a search of either a preselected or custom group of data fields and then access either a report for each incident identified by the search or a list of such incidents with a synopsis of relevant data field entries or map the incidents identified by the search by plotting the incidents on a geographic grid with each incident being represented by a unique icon that is related to a class of crime or type of incident identified.

Accordingly, it is a primary object of the present invention to provide a new system and methods for linking multiple events involving firearms that will assist in the investigation of such incidents.

This and further objects and advantages will be apparent to those skilled in the art in connection with the drawings and the detailed description of the preferred embodiment set forth below.

### BRIEF DESCRIPTION OF THE DRAWINGS

FIG. 1 is a screen shot of a main menu of a computer screen that is running a preferred embodiment of a program utilizing the present invention.

FIG. 2 is a flow chart depicting the flow of data from the main menu shown in FIG. 1 wherein the flow is tied to selection of the first menu option.

FIGS. 3-5 are flow charts depicting the flow of data from the main menu shown in FIG. 1 wherein the flow is tied to selection of the second through fourth menu options, respectively.

FIG. 6 is a screen shot of options accessed as page 2 from FIG. 1.

FIGS. 7-13 are flow charts depicting the flow of data from the menu shown in FIG. 6 wherein the flow is tied to selection of the first through seventh menu options, respectively.

FIG. 7A is an illustrative sample of a report of firearms correlated incidents between specific dates.

FIG. 8A is an illustrative sample of a report of weapon type, caliber and NIBIN entry status.

FIGS. 9A and 9B are an illustrative sample of a report of bullet caliber, lands, grooves and twists.

FIGS. 10A and 10B are an illustrative sample of a report of weapon caliber and grid.

FIG. 12A is an illustrative sample of a report of all firearms correlated incidents.

FIG. 14 is a screen shot of options accessed as Technical Firearms Information Input from FIG. 1.

FIG. 15 is a screen shot of options accessed from the first option of FIG. 14.

FIGS. 16-21 are flow charts depicting the flow of data from the menu shown in FIG. 15 wherein the flow is tied to selection of the first through sixth menu options, respectively.

FIGS. 22-27 are flow charts depicting the flow of data from the menu shown in FIG. 14 wherein the flow is tied to selection of the second through seventh menu options, respectively.

FIG. 22A is an illustrative sample of a firearms analyzed evidence NIBIN entry report.

FIG. 23A is an illustrative sample of a firearms analyzed evidence non NIBIN entry report.

FIG. 24A is an illustrative sample of a firearms analyzed evidence link comparison report.

FIG. 28 is an example of an interactive query map generated from a search result of the system of the invention.

FIG. 29 is a screen shot of a main menu for a system combining a Firearms Correlation Module with multiple Gang Database Modules.

FIG. 30 conceptually illustrates how the Firearms Correlation Module and the various Gang Database Modules work together in an overall law enforcement environment and interact with various law enforcement personnel.

### DETAILED DESCRIPTION OF THE INVENTION

### I. Introduction

A first component of the present invention provides a system and methods for increasing the efficiency of law enforcement agencies through targeted prioritization of investigating links related to firearms evidence. This is what is disclosed in our prior application, U.S. patent application Ser. No. 11/284,534, and after it is fully described in the present invention, it will subsequently be referred to as the Firearms Correlation Module, generally designated 110.

A second component of the present invention provides a Gang Database of gang related information that can be accessed by Gang Database Modules, nine in total, that work with the Firearms Correlation Module and each other to efficiently and effectively investigate gang-related crimes where firearms have been used and bring them to successful closure although one or more of such Gang database modules could be combined together. The reason the Gang database modules have not been so combined in the present description is that it is believed they will work more effectively if they are separated so that various personnel who might use such modules can focus on specifics, which is believed easier to use, than having to deal with more information bundled in fewer modules, all of which will be described later on.

Throughout this application, certain terms are given their normal meaning in the law enforcement community involved in investigating firearm related incidents. For ease of reference and for those not familiar with such terminology, the following glossary of a few common terms should prove helpful:
Class characteristics are those characteristics that are determined by the manufacturer before the manufacturing of the firearm such as caliber, number of lands & grooves, and measurements of the lands & grooves.
   NIBIN—National Integrated Ballistic Identification System
   Cold case links—Criminal incidents not previously known to be related are linked to each other.
   Cartridge—A unit of ammunition consisting of a cartridge case, bullet, gunpowder and a primer.
   Cartridge case—A brass cup that contains the primer, gunpowder and bullet.

It is also worth noting that the present invention is directed to the law enforcement field and a person of ordinary skill in the art to which the present application is directed should have some experience in this field and, ideally, in both the fields of firearm examination and gang investigations, although it is probably not likely that a single person will have extensive experience in both fields. Indeed, that is why the present invention is a result of collaboration between two different inventors, one with extensive experience in the field of firearms examination (who is a certified firearms examiner), and one with extensive experience in law enforcement and gang enforcement (who is presently a gang detective Sargent with approximately twenty years of experience in a major metropolitan police department in the United States with over 100,000 citizens).

We will now proceed to describe the Firearms Correlation Module and the Gang Database modules.

### II. The Firearms Correlation Module

An especially preferred Firearms Correlation Module in accordance with the present invention has a combined three-fold system that utilizes a combined database, mapping process and imaging capabilities.

The mapping portion (1) of the system is used to indicate all firearm related incidents as they occur on a daily basis. The map uses different symbols and icons that reflect the type of evidence (i.e., firearms seized, cartridge cases and bullets recovered). The map also reflects the case number related to the incident, the caliber of the evidence seized and the type of crime that was involved. This also reflects whether or not a case has been examined and entered into the NIBIN system by the crime lab. An icon reflects if the lab has not examined the case. When the icon is removed it reflects that the casework was completed. This gives a real time view of what is occurring in the city in regard to the hot spots of gun related activity. No matter what the priority of the incident, it is entered into the database and reflected on the map. This information is to be utilized by Detectives and Crime lab technicians to help prioritize casework based on the location of the incident and not just based upon the severity of the crime. The information is also available to patrol officers so they can review what incidents are occurring in their prospective patrol areas from the previous days, weeks or months. This helps officers know what type of crimes have occurred in their area of assignment, as well as suspect descriptions, and/or the type of firearms the crime lab and detectives are looking for that were involved in recent incidents.

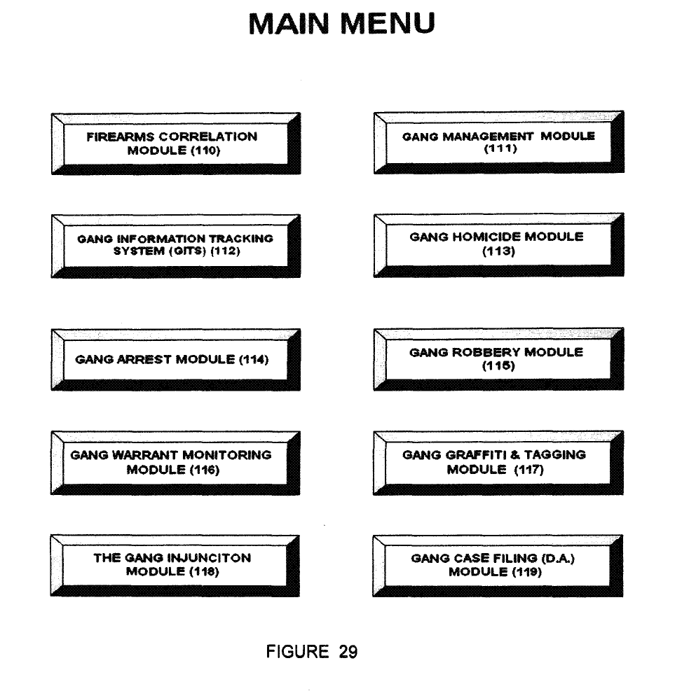

The database (2) portion of the system is the brain that drives the system. Entries into the data base system involve specifics of the crime such as the case number, crime type, caliber, brief synopsis of incident, and mapping grid. A unique part of this system is the ability to visually see on a map the results of any search results from the database system. This data and mapping visualization is available to the lab technician, detective and patrol officer. For example: a detective or technician wants to see how many firearms related incidents had .45 caliber cartridge cases recovered from crime scenes. The map would then show indicators of where each of the .45 Auto shootings occurred. (For an illustrative example of how such a map might look, see FIG. 29.) It would then determine which shooting had not been entered into the NIBIN system. The firearms technician can then enter the evidence into the NIBIN system in a search for possible cold case links to other shootings.

The imaging portion (3) of the system which give both detectives and crime lab personnel the ability to see what is going on in the city, view in real time criminal gang activity using firearms, see hotspots and know the caliber of firearms being used in that area, is a tremendous asset. This enables the detective to alert patrol units as well as allows patrol officers the ability to see what type of firearms they are looking for and the areas where the activity is occurring. This program gives the detectives a proactive approach to fighting crime and an overall view of the activity through the interactive database thus allowing community orientated policing that is not just reactive. This affords officers the ability to view firearms related incidents and determine where they are a problem for that particular state, county, city and/or neighborhood.

By using this system crime lab personnel can review the type of incidents occurring on the streets and determine if minor cases which are normally not requested by the detectives right away should be pulled from the evidence room and entered into the NIBIN system. This promotes a more interactive communication between the crime lab, detectives and patrol because they have access to the same system at the same time.

Larger higher producing labs which have many NIBIN hits result in detectives having problems managing the information (criminal intelligence) that is gathered as a result of linking cases to each other that were not previously known to be linked.

Success with the NIBIN system results in a large amount of data that is basically unmanageable from a high producing laboratory. Detectives workloads are tremendous to begin with Adding the links information will just add to the burden of managing the data. However, the present invention provides a central storing house for all of this information and data. The links of different cases through firearms incidents are recorded in the database. By using the program detectives have an easy way of getting necessary information regarding crime related incidents that they are investigating.

The present invention is also a time saving tool because it cuts down on time consuming report writing by examiners related to NIBIN entries and hits by enabling automatic report writing for the firearms examiners. This cuts down on the time used for writing of reports pertaining to NIBIN links. Moreover, this system is easily adapted for any format used by any department for recording links between firearms related incidents.

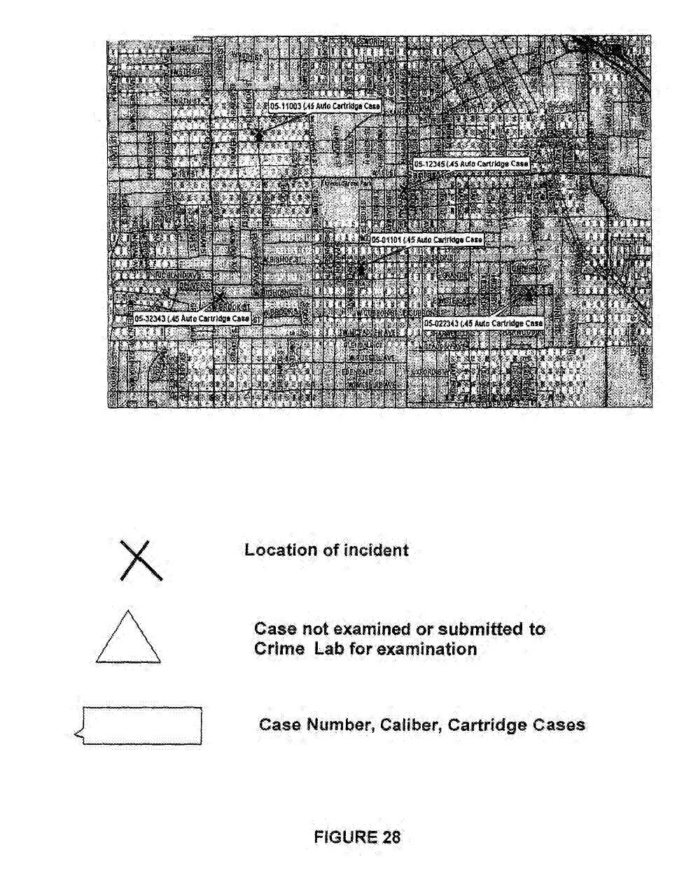

Another advantage of the present invention is that it provides a solution to the problem of there not being a way to effectively screen what cases are sent to the crime lab for examination. The present invention solves this problem by providing database capabilities as well as visual acuity by showing indicators of which cases have been sent to the lab for examination, entry into NIBIN and those that have not FIG. 28 shows how icons on the mapping portion of this program depict those cases sent to the lab for examination, those completed and those cases which have not yet been submitted. When a case has been completed the indicator for that incident showing that the case has been sent to the lab for examination is subsequently turned off. The results are then sent to the department. This icon can be changed or removed by Lab personnel once the examination has been completed.

Another advantage of the present invention is that it provides for the screening of class characteristics such as whether a cartridge case has a circular firing pin, elliptical firing pin, arched, parallel, cross hatch, smooth or granular breech faces. All of these are important screening characteristics that can be determined by a firearms technician (officer trained in class characteristic screening) prior to lab request submission, but for which there is presently no real way to use such data as an effective screening tool. For example: Three shootings occur in a neighborhood all involving 9 mm Luger in caliber firearms. The cartridge cases recovered from each of the three crime scenes disclose that two of the shootings cartridge cases have circular firing pins with parallel breech faces. The other cartridge case (from the third case) has an elliptical firing pin (indicative of being shot in a Glock or Smith & Wesson Sigma). The technician submits the two cartridge cases to the lab for examination indicating that the two cases have class characteristic similarities and should be prioritized by the lab for entry into the NIB IN system, while the third does not.

Further, the database portion of this program allows bullets to be entered so that class characteristic screening can be accomplished. Screening of bullets includes caliber, number of lands & grooves, direction of twist, as well as measurements of the lands & grooves to be sorted and screened to determine if they have the same class characteristics of other shootings. For example: Four shootings occur in a given area all involving 38/357 in caliber bullets. Two of the shootings have 5 lands & grooves with a Right twist, one has 6 lands and grooves with a right twist and another has a right twist but the bullet is so damaged the number of lands and grooves cannot be determined. The two 38/357 disclose that they have the same or very close to the same lands and groove measurements. The third bullet with the 6 lands & grooves is immediately eliminated because of the difference in the number of lands & grooves. The fourth bullet has the same measurements of lands and grooves and is then sent to the lab along with the first two bullets to see if they are related shootings. The third bullet is not submitted unless other shootings occur in the area that have 38/357 in caliber bullets with a right twist.

The present invention is also very advantageous for smaller police departments for which the NIBIN systems are too expensive. Smaller departments rely on bigger departments or sheriffs departments for their information to be entered into the NIBIN system. The present invention is more cost effective and also provides the ability to screen what is being submitted to the crime lab. This helps in turn around time for the laboratory and also helps with the ability for the department to screen evidence prior to being submitted to the lab for examination. The system of the present invention can be adapted for use in any police department around the nation and can be used in conjunction to enhance the capabilities of the NIBIN system. Firearms examiners are not abundant and are expensive to train. With this system police personnel can be trained to do information entry into this system, class characteristic screening and determine what needs to be sent to the lab as a priority, which is a huge improvement compared to current best practices of such departments that have no effective way of screening and prioritizing such requests.

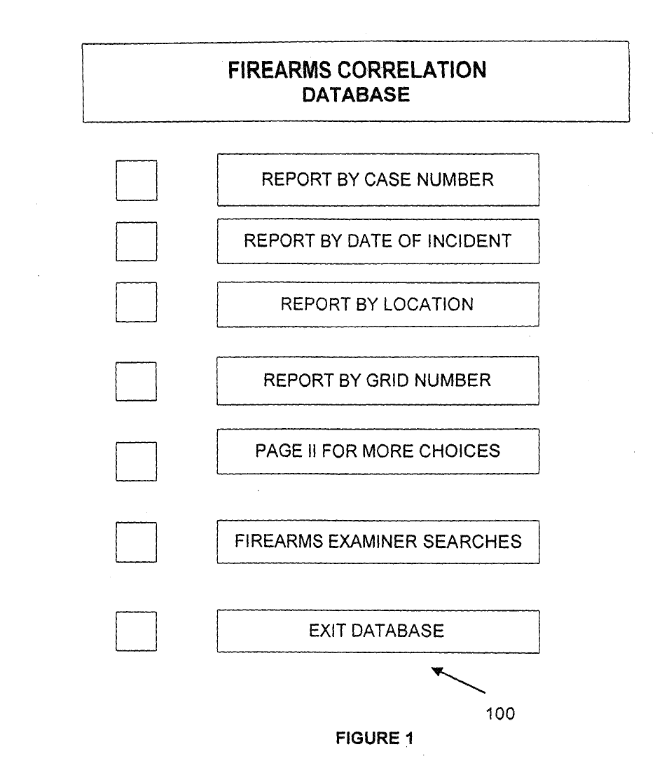

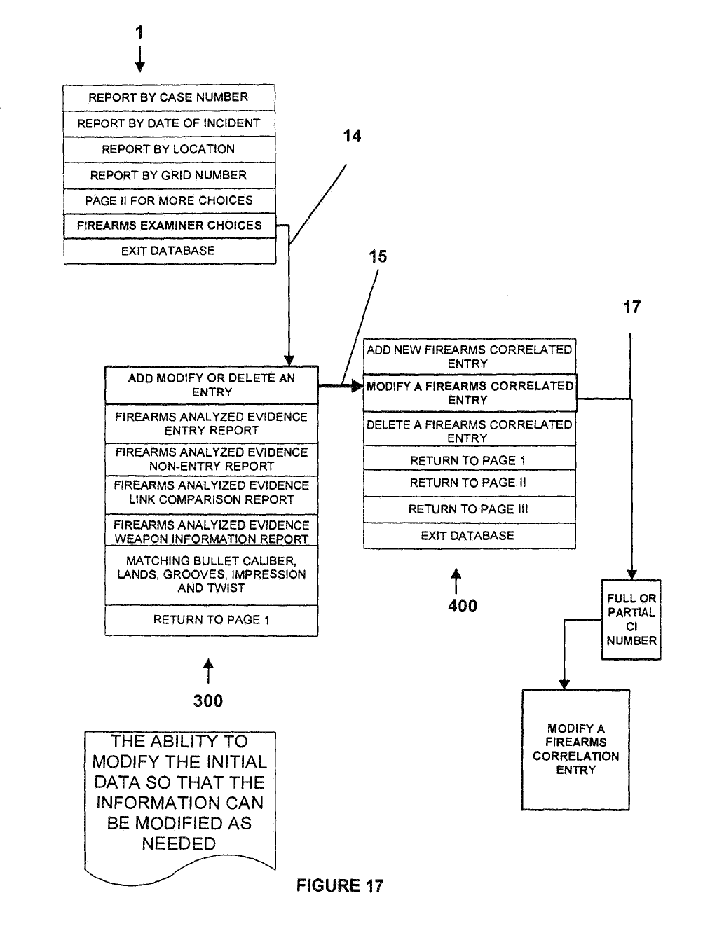

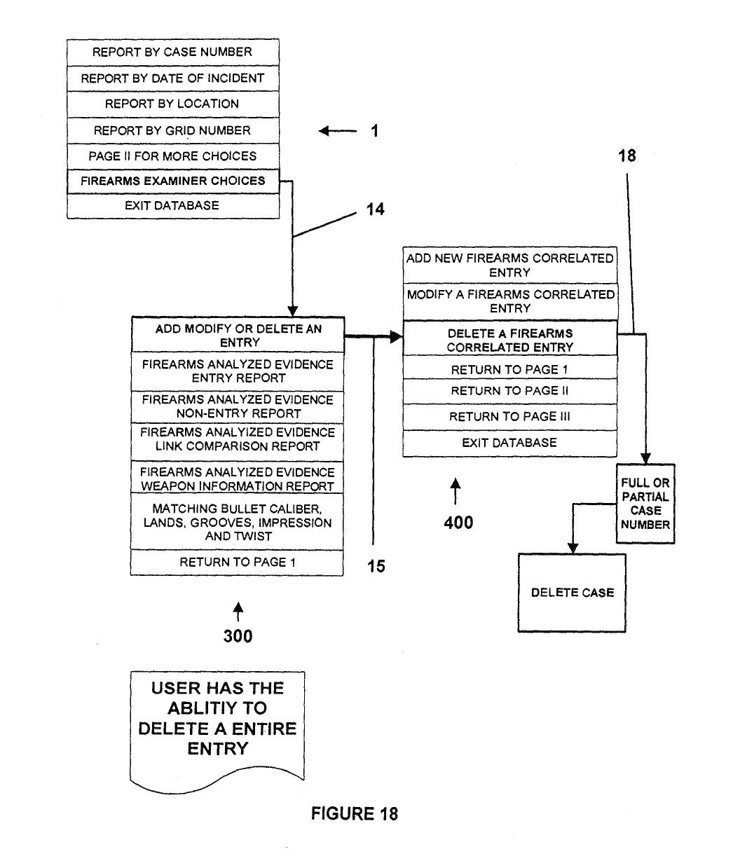

The present invention will now be described in even greater detail by reference to a preferred embodiment of a system of the present invention that is based, in part, upon an experimental prototype system that has actually been used to prove and test the concept of the present invention in a real setting. Significantly, the prototype, which does not have the advanced mapping and imaging aspects of the present invention fully implemented, is setting national records in the number of cold case links. The cold case hits using this system have resulted in increases between 300-600%. FIGS. 1-28, which will be described in greater detail below, provide a roadmap of this prototype system currently being tested, including certain refinements that have recently been made to enhance its performance. However, the following description is not meant to be limiting of the scope of the present invention, but, instead, to be illustrative of how the concepts already described can effectively be put into practice. Thus, as already noted, it is expected that a fully deployed version of the present invention will have enhanced imagining and mapping capabilities, and the report writing functions will be keyed to specific reporting needs. Also, it is anticipated that such a system will include user friendly tutorials specifically directed to targeted entries to aid in its successful implementation, especially for law enforcement agencies that do not have a trained firearms examiner.

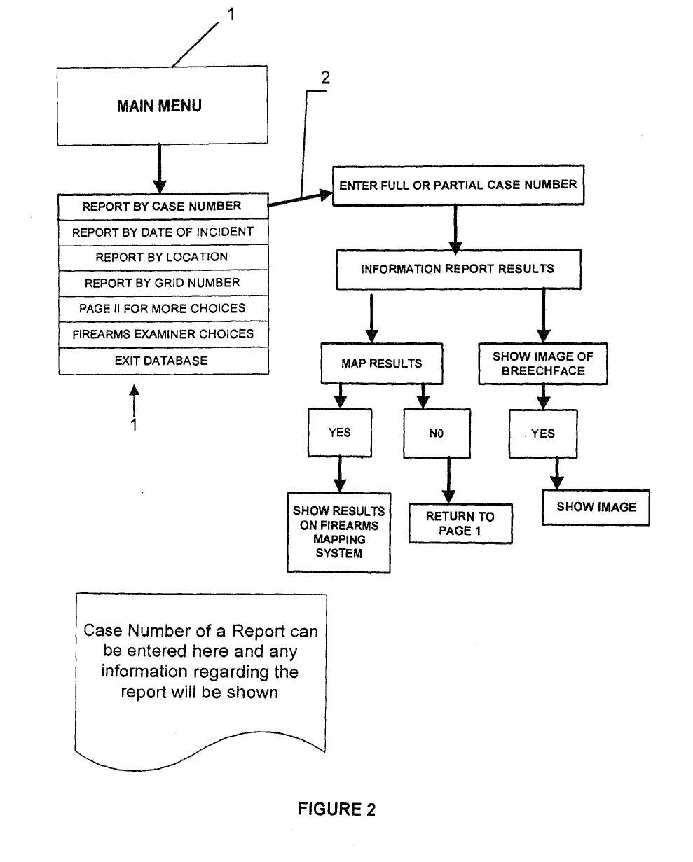

A computer network or a single computer, such as a desk top or lap top, is outfitted with a program that, once it has properly been opened (which may require a password) begins with an initial opening home page 100 (shown as FIG. 1) that is geared toward generating reports useful to many different types of law enforcement personnel. The main menu 1 (see FIG. 2) found in home page 100 allows data to be searched for information by a number of different criteria so as to create a wealth of choices which gives law enforcement officers a variety of ways to search for related information depending upon what is known for a given incident, and multiple searches may be performed quickly and efficiently and combined into a single composite report derived from multiple searches (not shown).

As shown in FIG. 2, Step 2 allows a user to display information about a case once its full or partial case number is entered and the user can either choose to map such results or show an image of the cartridge case for the case (if it exists). The partial case number entry can allow searching of the portion of the number which is known, thus simplifying the process and saving time when the whole case number is not remembered. Thus, for this option, the program allows the user to enter the case number of the report and obtain any information regarding that case that was previously entered and the case can be shown on the linked mapping system if the user wishes to do so. While the image of the cartridge case cannot, by itself, be used to establish a link, it can help narrow potential links when images of the cartridge case are also present in other cases that might be potentially linked to a chosen case.

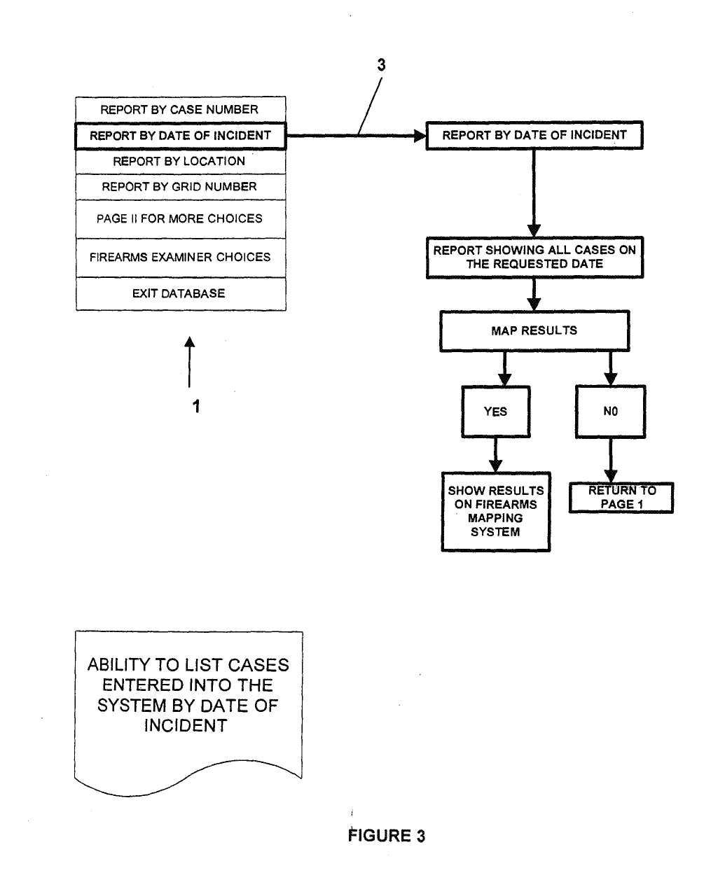

As shown in FIG. 3, Step 3 allows a user to search for cases by a specific date, and then to map the results of the search.

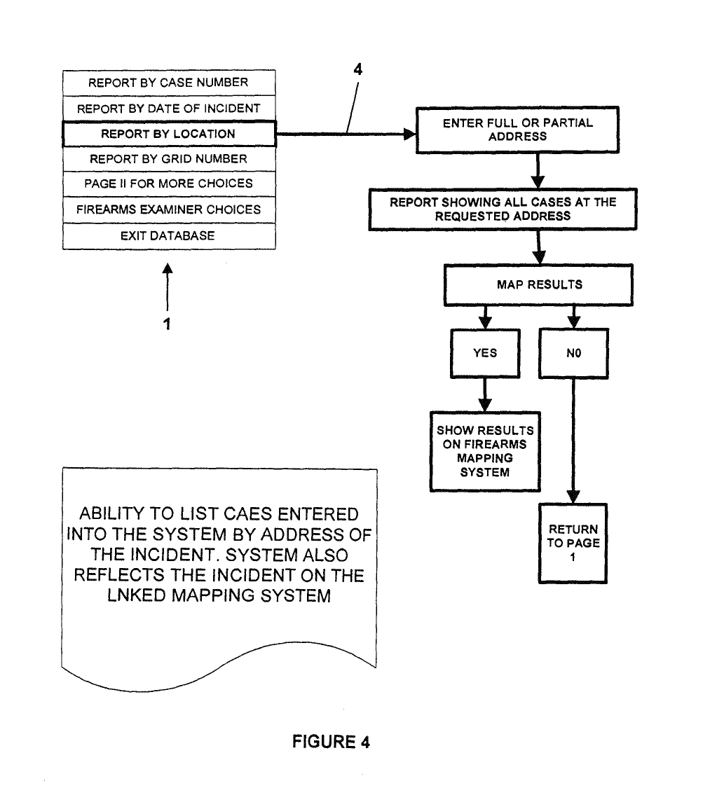

As shown in FIG. 4, Step 4 allows a user to list cases entered into the system by address of the incident and to map other incidents at the same location.

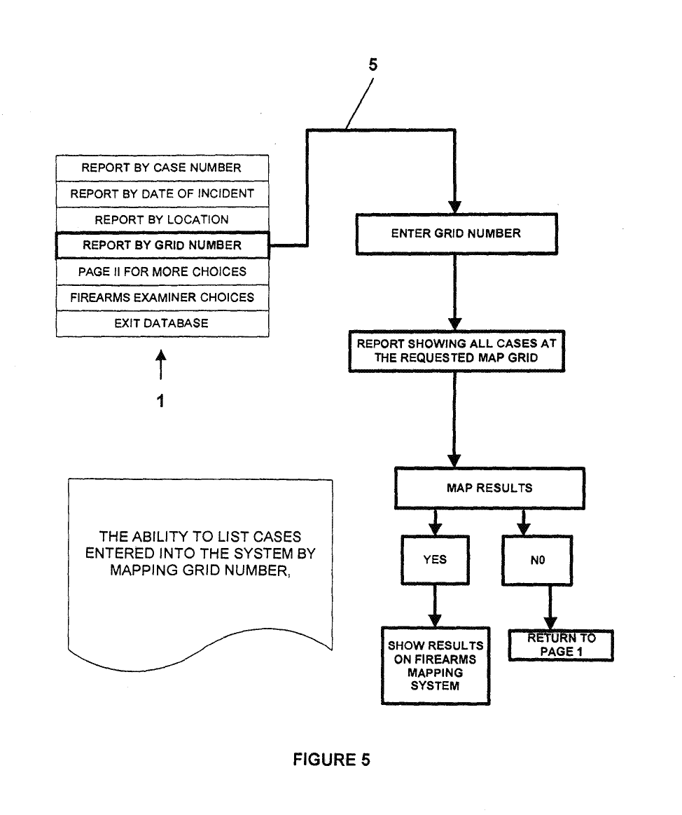

As shown in FIG. 5, Step 5 allows a user to enter a grid number from a map and obtain a report showing all cases at the requested map grid, and then these incidents can be mapped. This step can also be designed to allow for multiple map grids to be entered in a single query, or for additional map grids to be added to the results of an initial query.

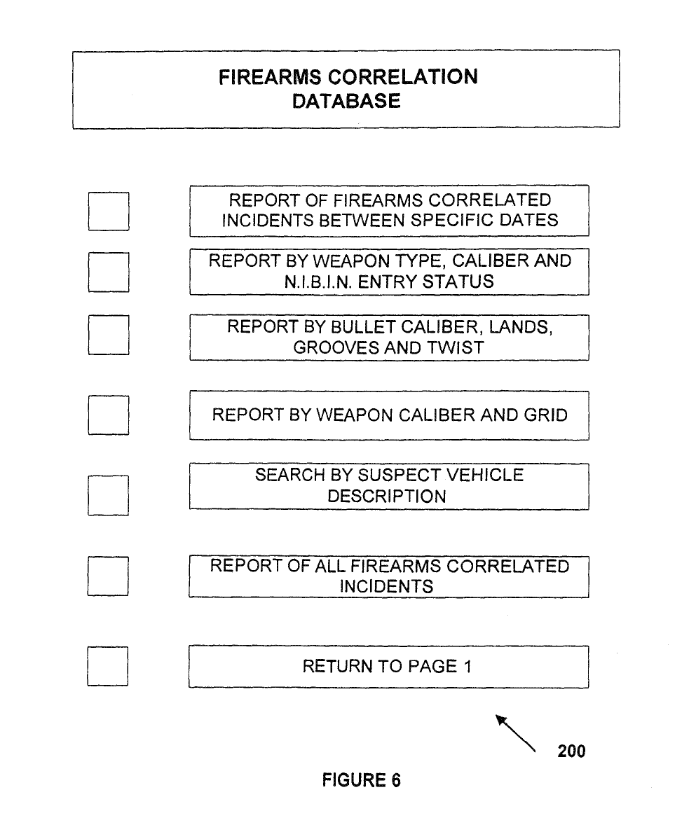

From home page 100 a user can also go to additional menu page II, 201, by step 6 (a screen shot of page II, 200, is shown in FIG. 6) to access additional search possibilities.

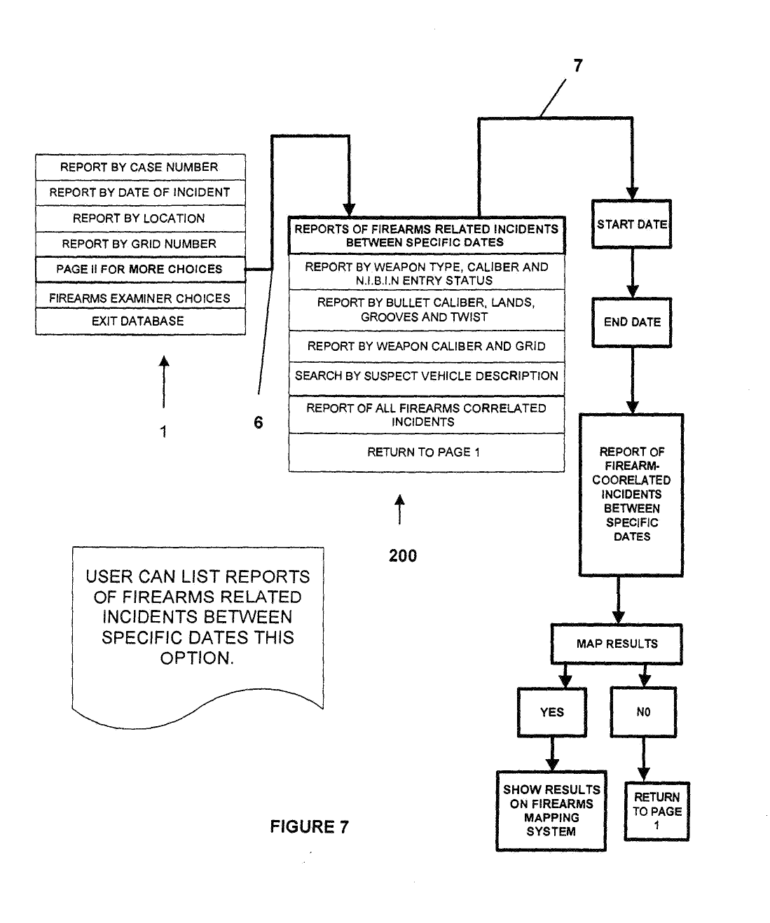

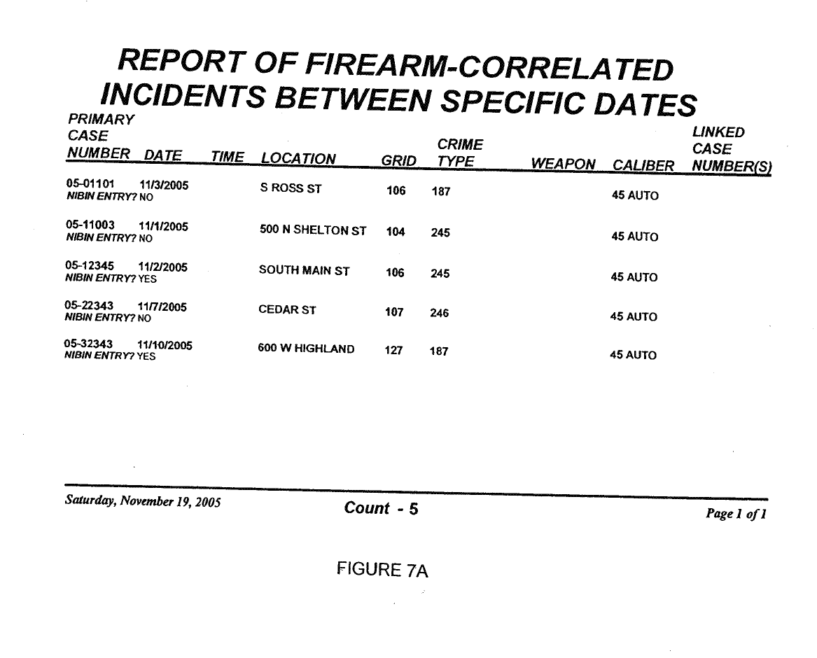

As shown in FIG. 7, Step 7 allows a user to obtain reports of firearms related incidents between specific dates by entering start and end dates for the search and then map such results. FIG. 7A is an illustrative sample of a report of firearms correlated incidents between specific dates. This type of report can be especially useful for narrowing down dates when a witness or informant cannot recall an exact date, but is aware of a general time frame, or when a detective wants to review shooting incidents a particular time frame such as, for example, when the detective may not have been working or reviewing information.

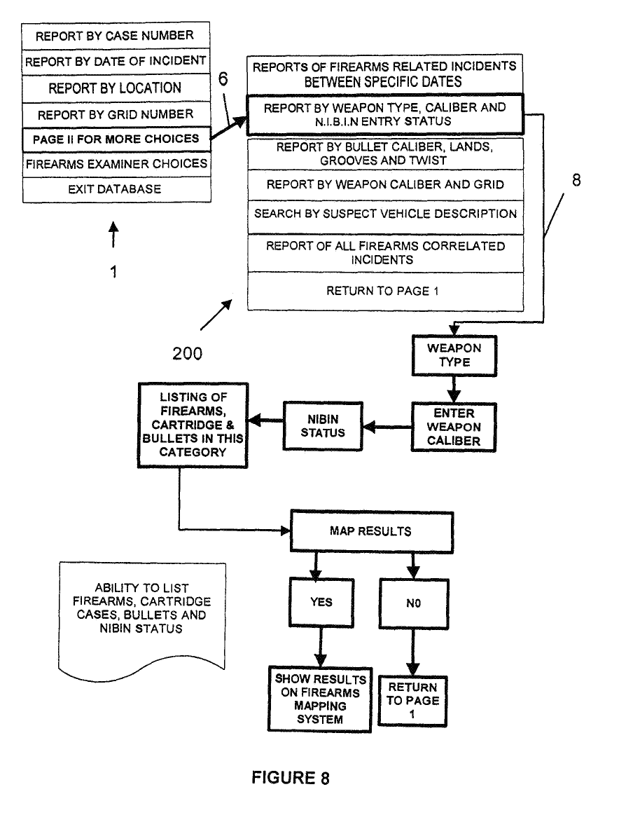

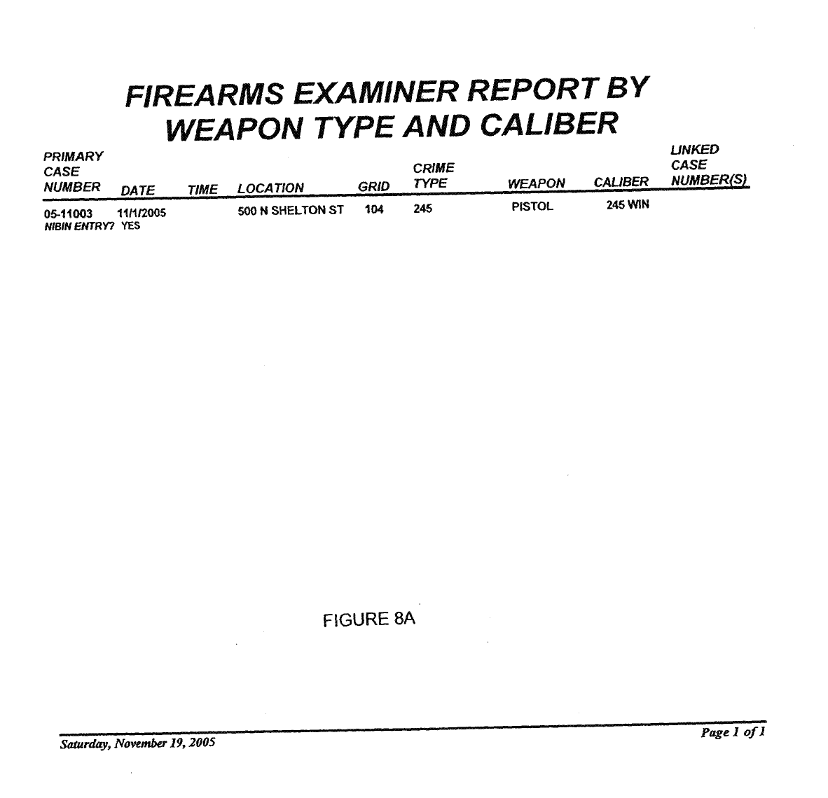

As shown in FIG. 8, Step 8 allows a user to obtain reports based upon weapon type, caliber and NIBIN entry status, and then map such results. FIG. 8A is an illustrative sample of a report of weapon type, caliber and NIBIN entry status. This type of report can be especially useful for visually prioritizing shooting incidents where evidence recovered (i.e., bullets and cartridge cases) are of the same caliber as the weapon recovered from the suspect or insurgent. This helps to prioritize what is looked at by the firearm technician, thus saving time, expediting the analysis process and providing useful investigative information to detectives and/or military personnel on the scene.

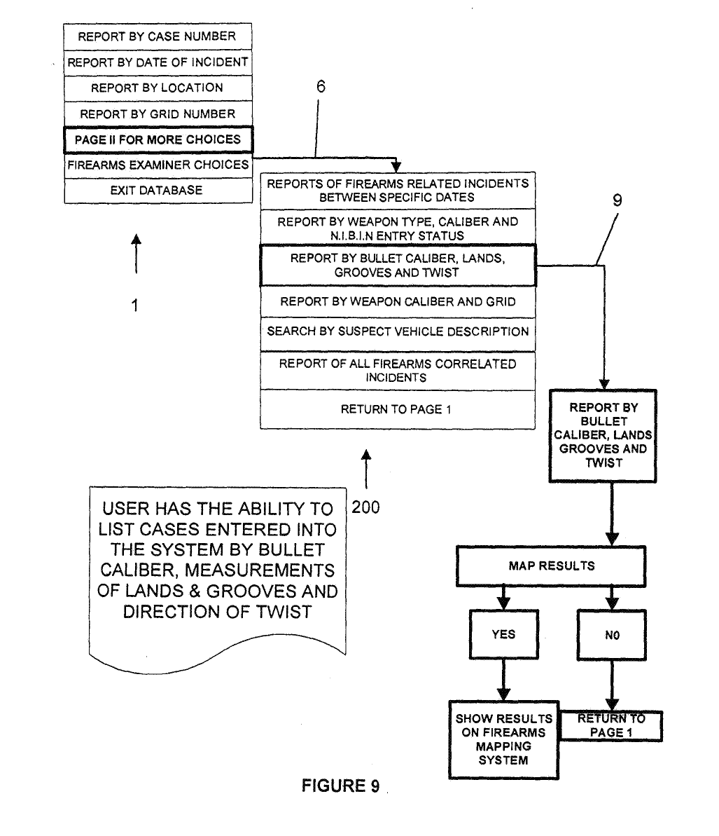

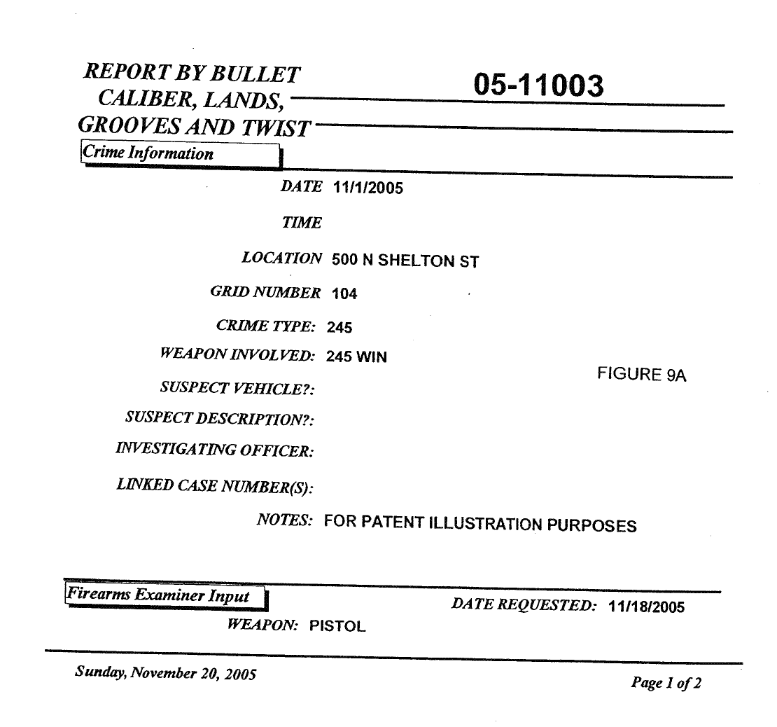

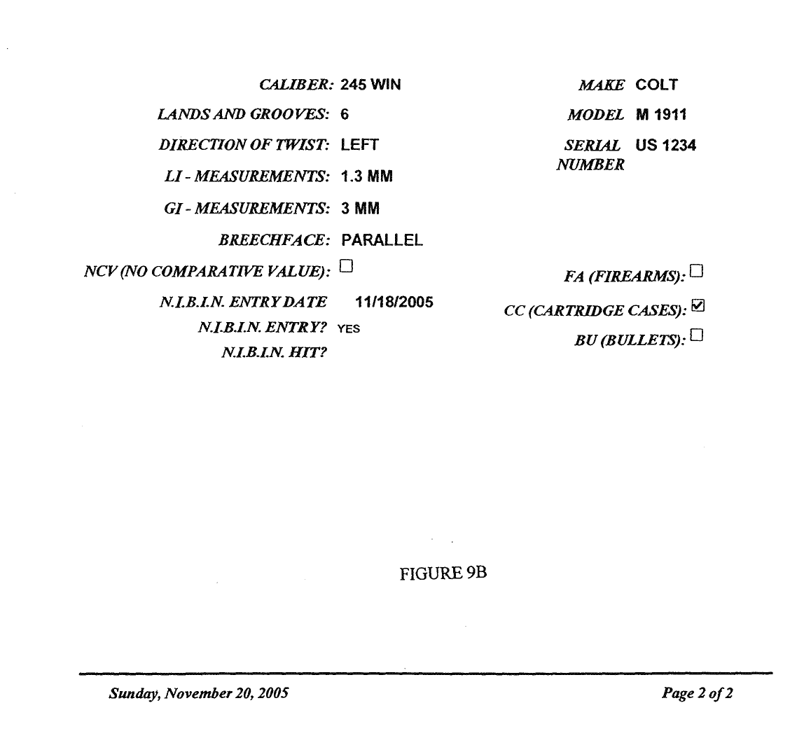

As shown in FIG. 9, Step 9 allows a user to obtain reports based upon bullet caliber, lands, grooves and twist and then map such results. FIGS. 9A and 9B are an illustrative sample of a report of bullet caliber, lands, grooves and twists. Significantly, this type of report is extremely valuable in prioritizing requests for possible link requests, yet this is the type of data that might otherwise be lost in a “jungle” of data and something that presently does not receive sufficient attention from law enforcement agencies because of the lack of a system such as that of the present invention.

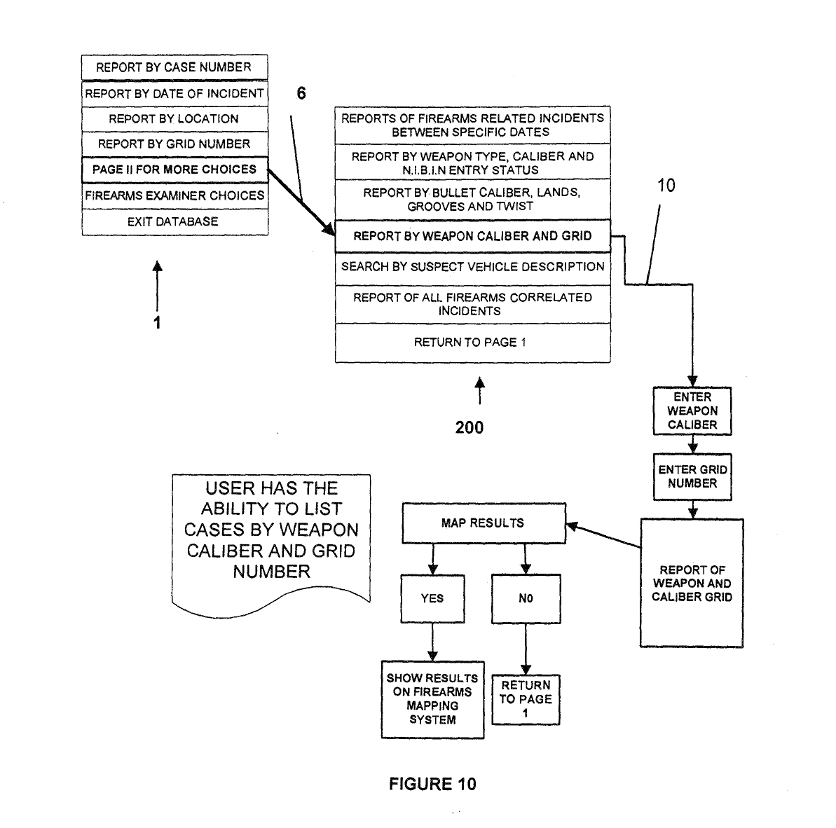

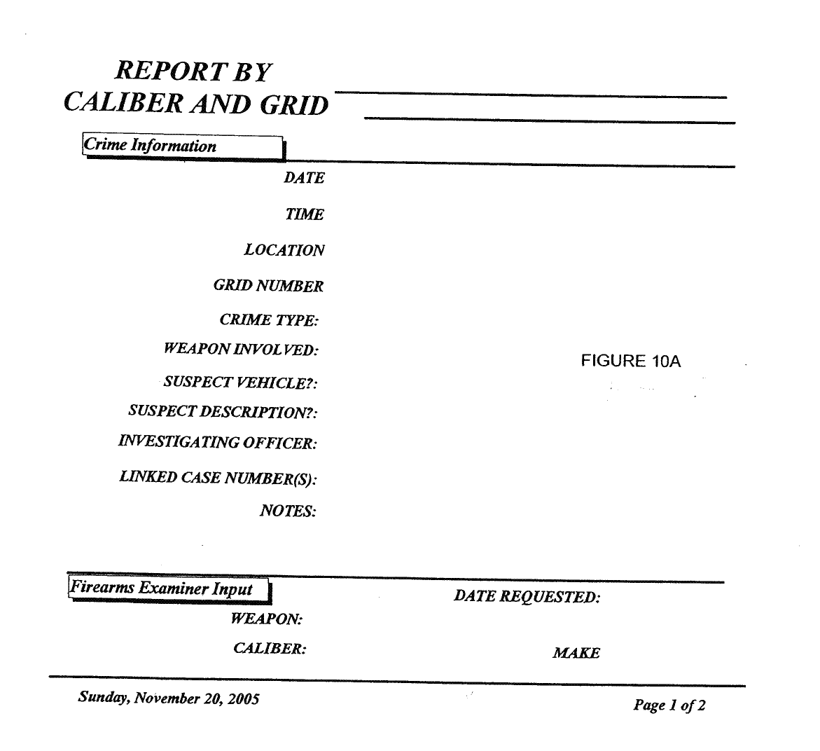

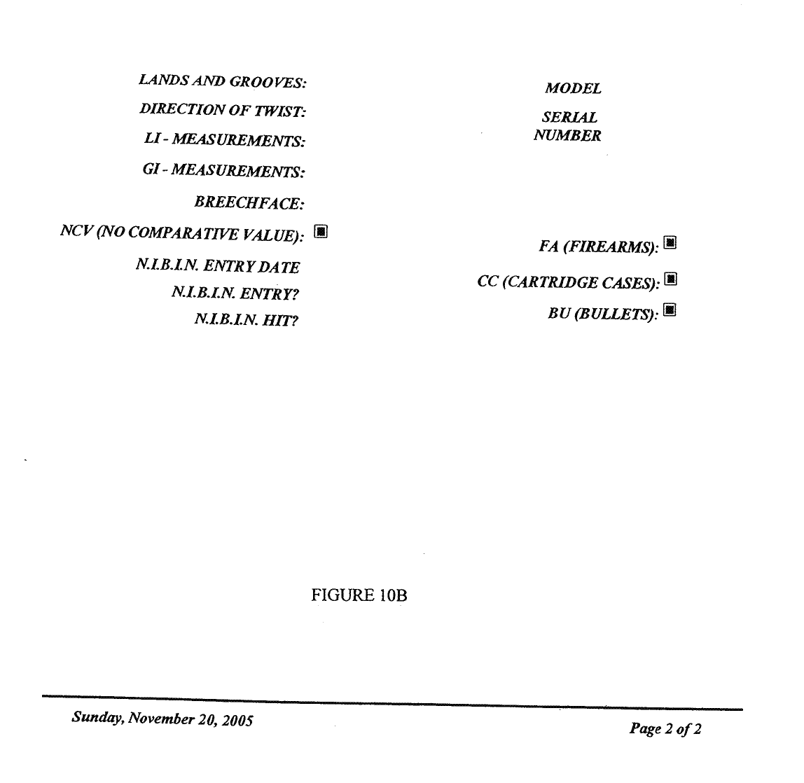

As shown in FIG. 10, Step 10 allows a user to obtain reports based upon weapon caliber and grid, and then map such results. FIGS. 10A and 10B are an illustrative sample of a report of weapon caliber and grid. This type of report can be especially useful for when a detective wants to see specific firearm related incidents for a specific mapping grid for a city.

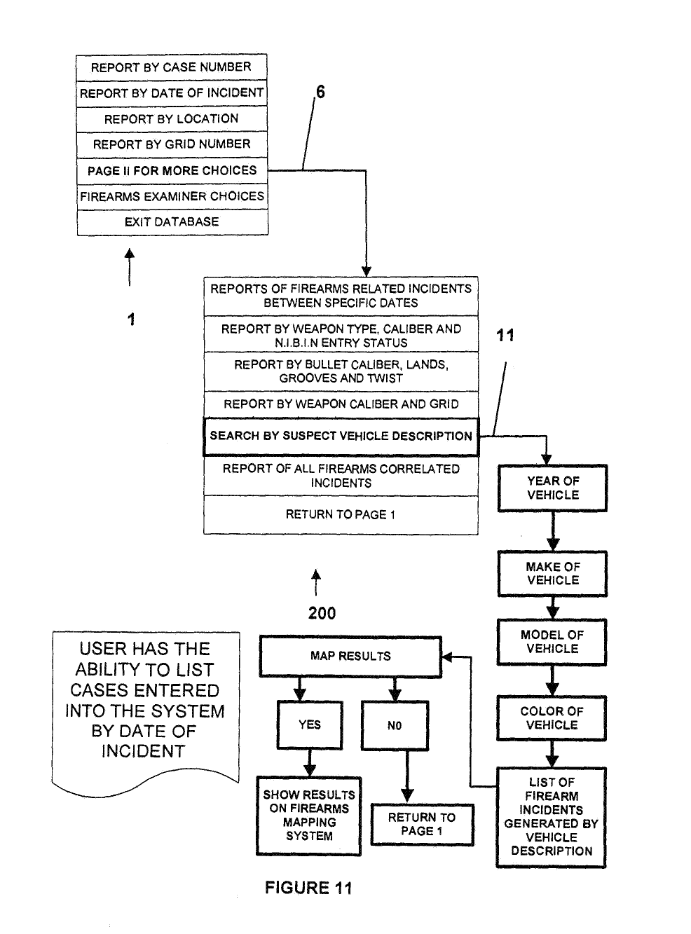

As shown in FIG. 11, Step 11 allows a user to search by suspect vehicle description and then map such results. The advantage of this step is to allow detectives to correlate data that might otherwise not be so easy to correlate, especially if the results of such a search are combined with other search results.

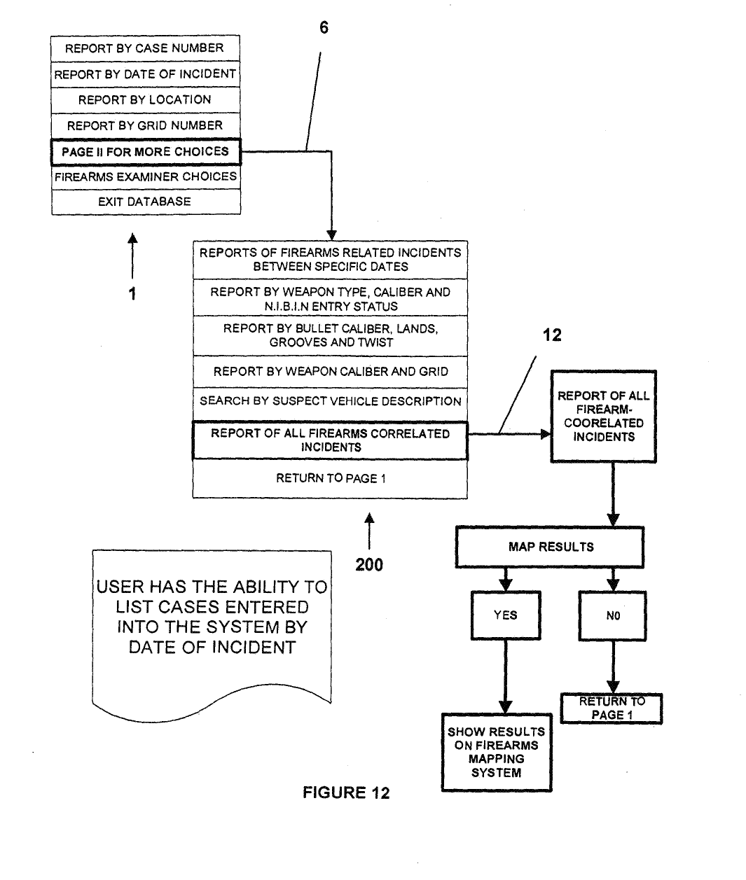

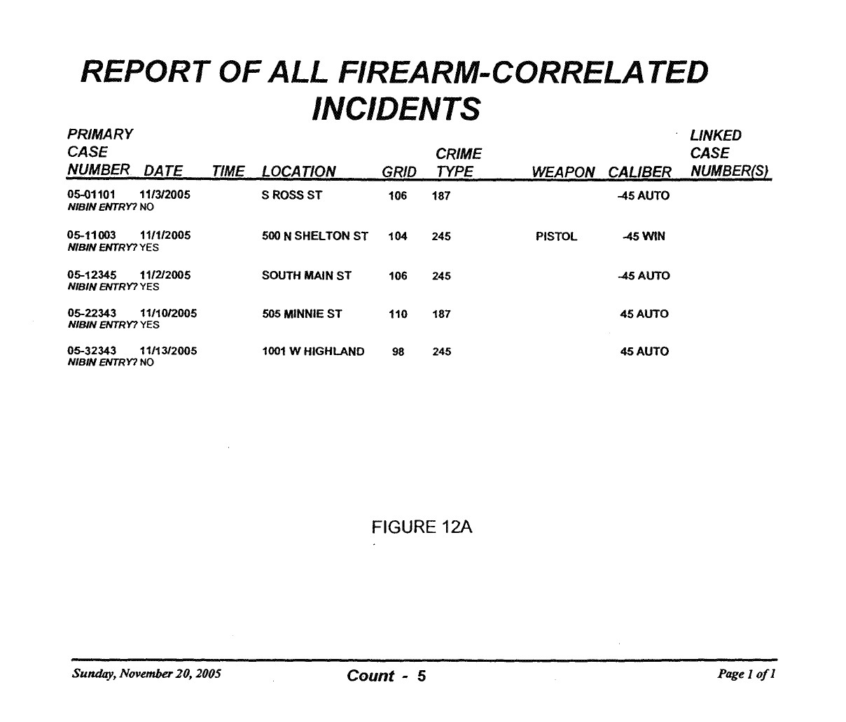

As shown in FIG. 12, Step 12 allows a user to obtain a report of all firearms correlated incidents. FIG. 12A is an illustrative sample of a report of all firearms correlated incidents. This type of report is especially useful for allowing a detective to list every piece of data that has been entered into the system database. This allows the detective to print out a hard copy of any data entered into the system.

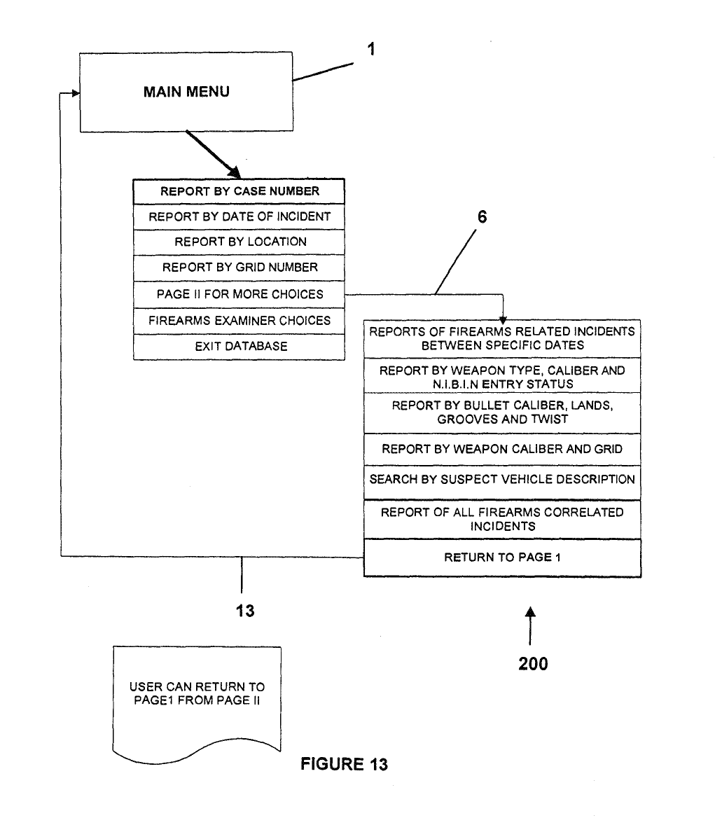

As shown in FIG. 13, Step 13 allows a user to return to home page 100.

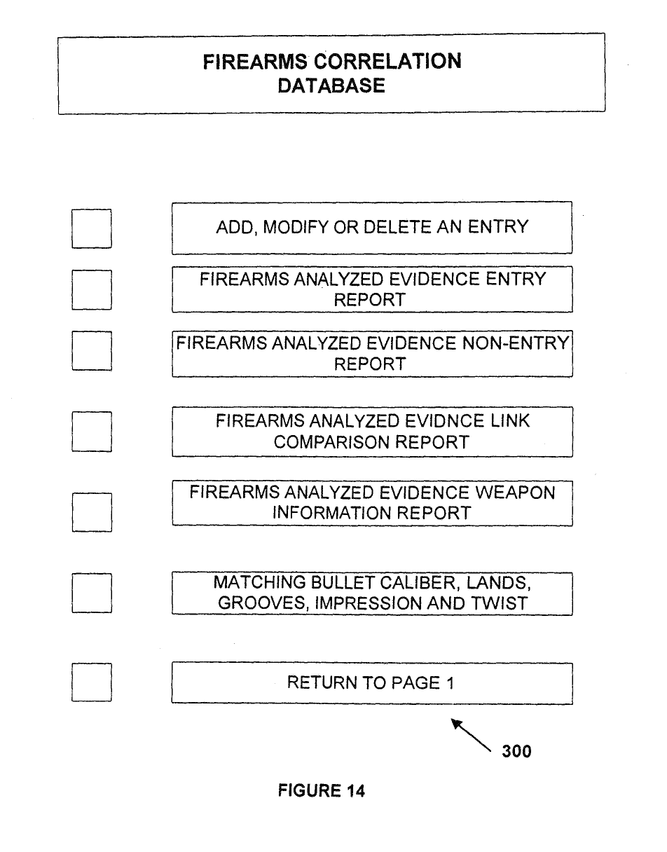

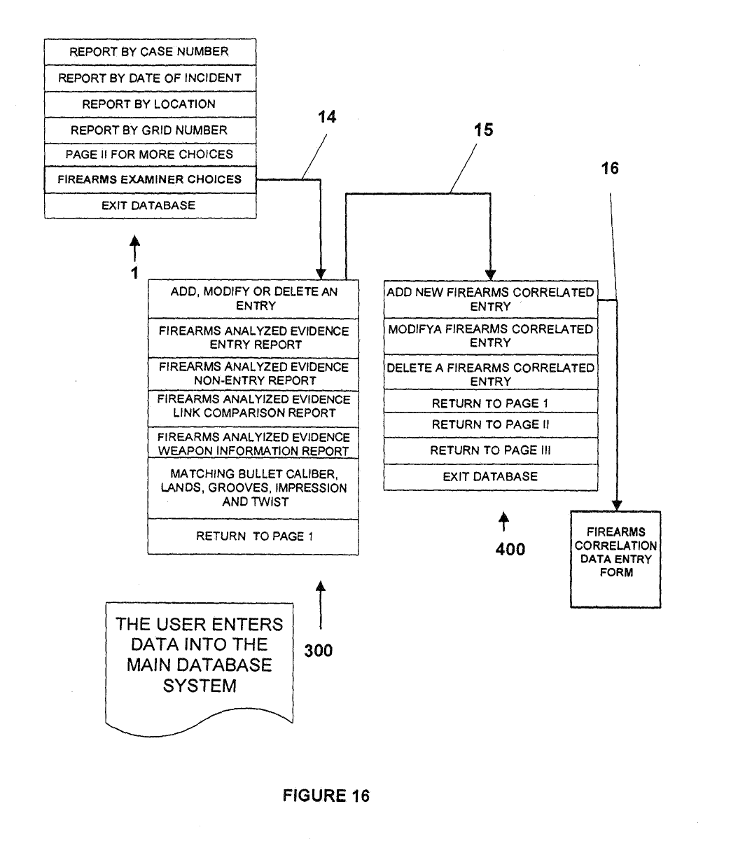

Up until now the reports that have been accessed from home page 100 are reports that are desirably, available to many different personnel in a given law enforcement agency, whether or not they have any firearms examiner training. In fact, it is desirable that both officers and detectives have access to the ability to easily generate such reports, and this can readily be accomplished by log-on rights in a network or a given device. However, Step 16, shown in FIG. 16 as Firearms Examiner Choices, opens a new page III (depicted in FIG. 14) which is the stepping off point for entering new data into the system, and this page and steps originating from this page should be limited to permitted users with authorized access for the action they undertake, and, ideally, back-up records should be kept of changes introduced through such access.

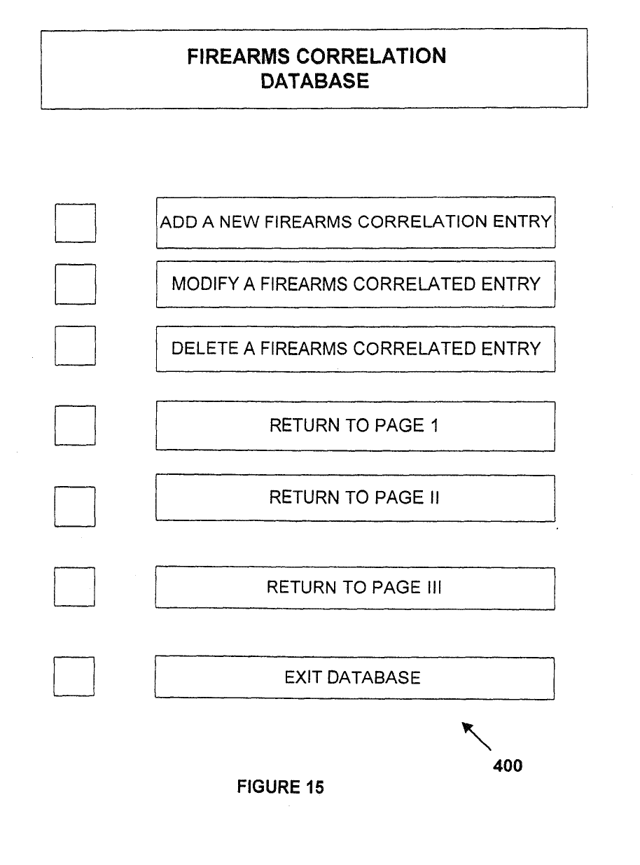

From page III, 300 (FIG. 14), once an authorized user selects step 16 to Add, Modify or Delete an Entry, the user will be taken to a new page IV, 400 (depicted in FIG. 15) from which these three actions can be taken as steps 16-18 as depicted in FIGS. 16-18, respectively. Tables 1 and 2 below list the various data fields that can be accessed by steps 16 and 17 and also provide a more detailed description of the information to be entered into these data fields.

TABLE 1
Event Information Data for Entry to the System Database

| | MORE DETAILED DESCRIPTION OF |
|---|---|
| CRIME INFORMATION | DATA FOR ENTRY |
| Primary Case Number | Case number assigned by the department on |
| | each incident |
| Linked Case Number | Case numbers of linked shootings to the |
| | primary case number |
| Date | Date of Incident |
| Time | Time of Incident |
| Location | Location of where the crime occurred |
| Grid Location | Mapping grid of where the incident occurred |
| Crime Type | Offense code |
| Weapon Caliber | Caliber of weapons pertaining to this crime |
| Suspect Vehicle Year | Year of suspect vehicle |
| Suspect Vehicle Make | Make of suspect vehicle - e.g., Toyota, |
| | Ford, Dodge, etc. |
| Suspect Vehicle Model | Model of vehicle - e.g., Camry, Civic |
| | Silverado, etc. |
| Suspect Vehicle Color | Color of vehicle - e.g., white, black, |
| | gray, green, etc. |
| Suspect Vehicle License | Any vehicle license numbers that may be |
| | obtained from witnesses |
| Suspect Description | Description of Suspects, e.g., shaved head, |
| | white shirt etc. |
| Investigating Officer | Detective assigned to the case |
| Notes | Information concerning the crime incident, |
| | e.g., suspect shot victims sitting at a red |
| | light at the intersection of 2nd Street and |
| | Flower |

TABLE 2
Firearms Information Data for Entry to the System Database

| FIREARMS EXAMINER | MORE DETAILED DESCRIPTION OF |
|---|---|
| INPUT | DATA FOR ENTRY |
| Date Requested | Date Detectives requested the examination |
| | by Firearms Unit |
| Requested By | Person requesting the examination |
| WEAPON | |
| Weapon Type | Pistol, revolver, derringer, shotgun and rifle |
| Caliber | Caliber of weapon, e.g., .45Auto, .38 |
| | Special, .22 Long Rifle |
| Evidence Type | Cartridge cases, bullets, firearms |
| Make | Make of weapon, e.g., Glock, Ruger, Sig |
| | Sauer, LLAMA, etc. |
| Serial Number | Serial number of seized firearm |
| BULLET DATA | |
| Lands and Grooves | Number of lands and grooves in the barrel of |
| | suspect weapon, e.g., 5, 6, etc. |
| Directions of Twist | Direction the bullet is spinning when it |
| | departs the barrel of the suspect's firearm |
| LI -Measurements | Measurement of the fired bullets Land |
| | Impression |
| GI- Measurements | Measurements of the fired bullets Groove |
| | Impression |
| NCV | No Comparative Value-Bullet is too |
| | damaged-No useful information obtained |
| N.I.B.I.N. | National Integrated Ballistic Information |
| | Network |
| NIBIN Entry Date | Date evidence (cartridge case or bullet) was |
| | entered into NIBIN system |
| NIBIN Entry | Was evidence (cartridge case or bullet) |
| | entered into the NIBIN system? |
| NIBIN Hit | Was there a link between evidence (cartridge |
| | case or bullet) to other cases? |
| Verification Date | Date the link between cases was verified by |
| | the crime lab examiner |
| EVIDENCE TYPE | Type of evidence recovered from the crime |
| | scene |
| FA (Firearms) | Was a firearm recovered from the crime |
| | scene - Check mark for yes |
| CC (Cartridge Cases) | Were cartridge cases recovered from the |
| | crime scene - Check mark for yes |
| BU (Bullets) | Were bullets recovered from the crime |
| | scene - Check mark for yes |
| Pellets | Were shotgun pellets recovered from the |
| | crime scene - Check mark for yes |
| Elliptical Firing Pin | Was the firing pin impression elliptical |
| | (rectangular) in shape - Check mark for yes |
| Breech face | Class characteristics of breech face |
| | impressions on cartridge cases recovered |
| | from the crime scene e.g. - circular, |
| | parallel, arched, crosshatch, etc. |
| Firearms Technician | Person responsible for entering the data |
| | into the Firearms Correlation Data Entry |
| | Form |
| List of Possible | Based on the Land and Groove |
| Manufacturers | Measurements obtained during examination |
| | from the recovered bullet the possible |
| | make and manufacturer of firearms that |
| | were used to fire the bullets can be |
| | determined |
| Non-Linked Case | Cases that were examined and determined |
| Comparisons | that they were not related to the Case |
| | (which saves doing duplicate work later) |

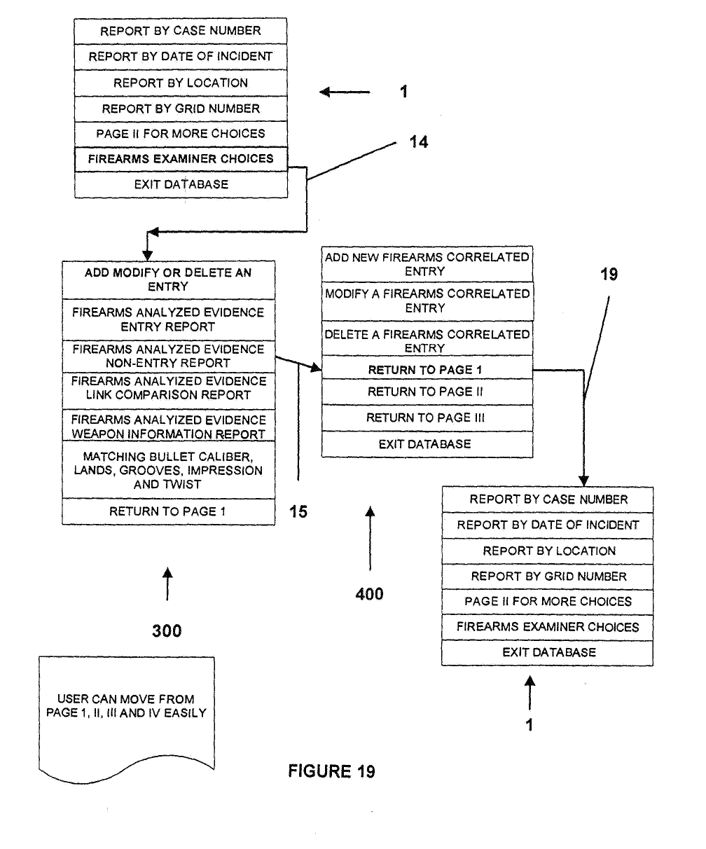

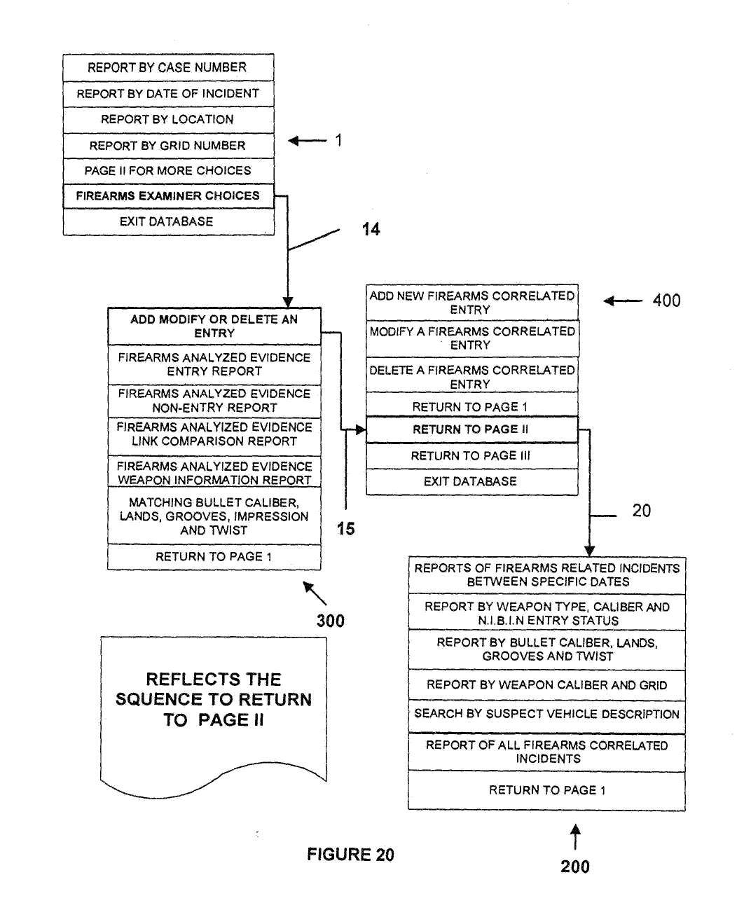

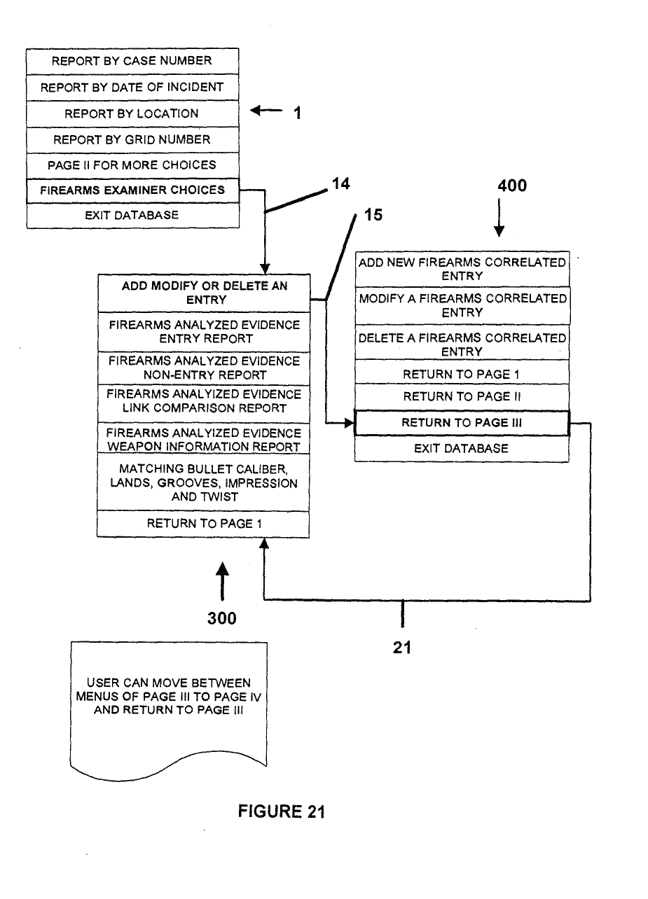

From page IV, 400 (FIG. 15), a user can return to home page 100 via step 19 (shown in FIG. 19), to page II (200) via step 20 (shown in FIG. 20) or to page III (300) via step 21 (shown in FIG. 21).

As already noted, data dealing with event information is preferably entered by an investigating officer, or at least based upon input by an investigating officer. Thus, for example, if an officer has a connection to the computer network on which the system database is kept, event information can be entered directly by the investigating officer, potentially even in real time; however, if the investigating officer does not have such access and prepares a standard paper report, the information from such a report can be transferred to the computer network by a clerical employee with permitted access for such data entry. By contrast, data dealing with firearms information should, preferably, be entered into the computer network by somebody with firearms examiner training (such as a firearms examiner or a firearms technician), or be transferred to the computer network by a clerical employee with permitted access for such data entry based upon the input of somebody with firearms examiner training.

Going back to page III (shown as 300 in FIG. 14), several different reports can be generated by a firearms examiner or a person with firearms examiner training.

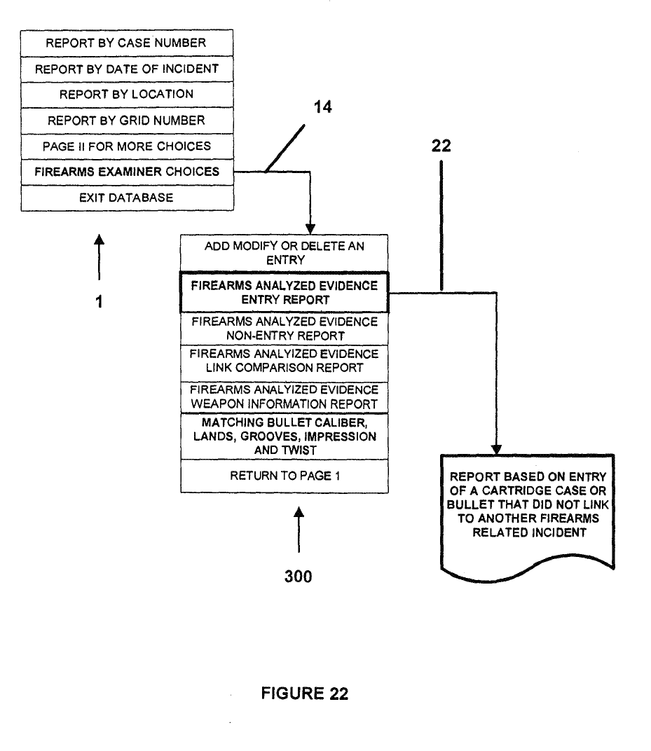

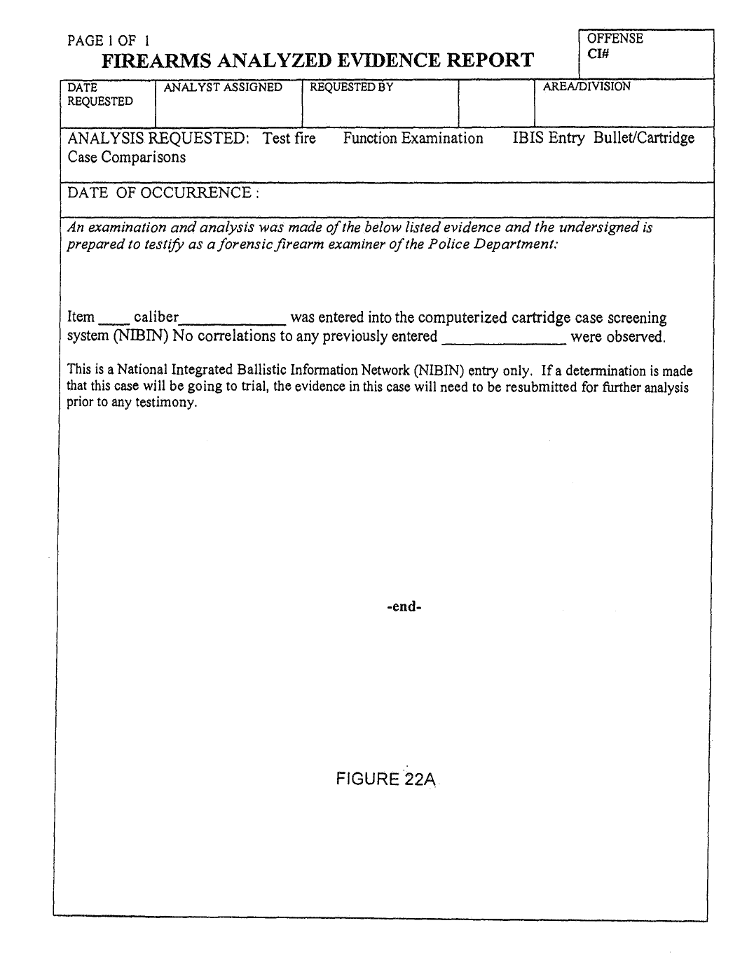

As shown in FIG. 22, step 22 will generate a firearms analyzed evidence entry report and FIG. 22A is an illustrative sample of such a report.

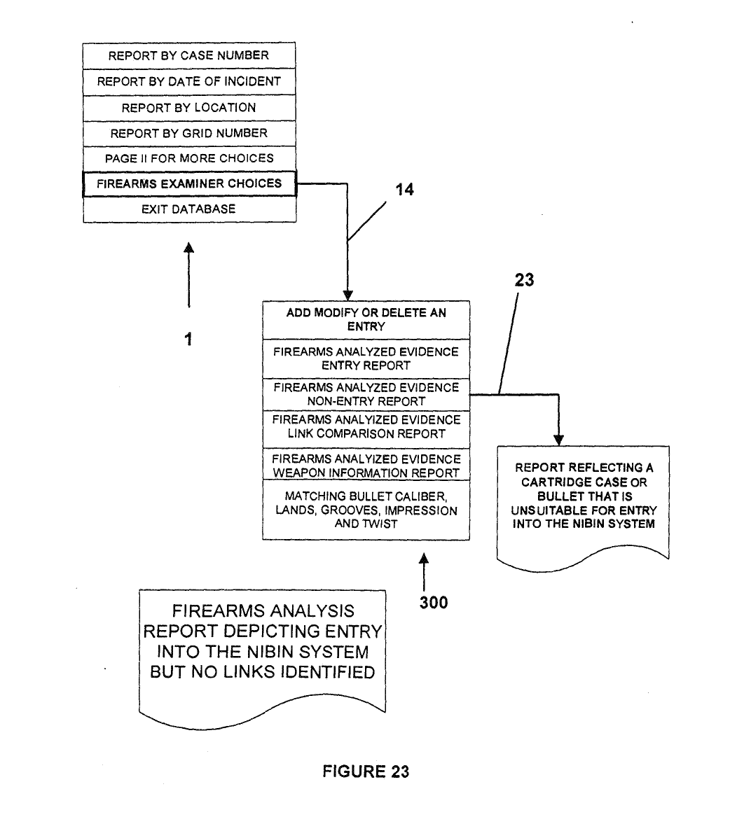

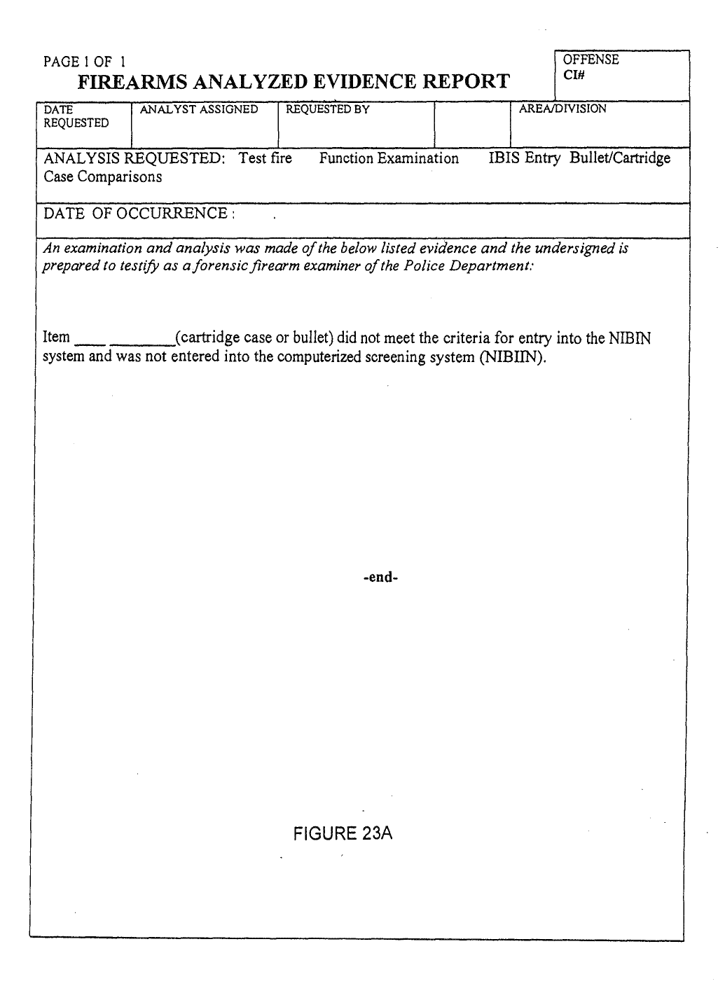

As shown in FIG. 23, step 23 will generate a firearms analyzed evidence non-entry report and FIG. 23A is an illustrative sample of such a report.

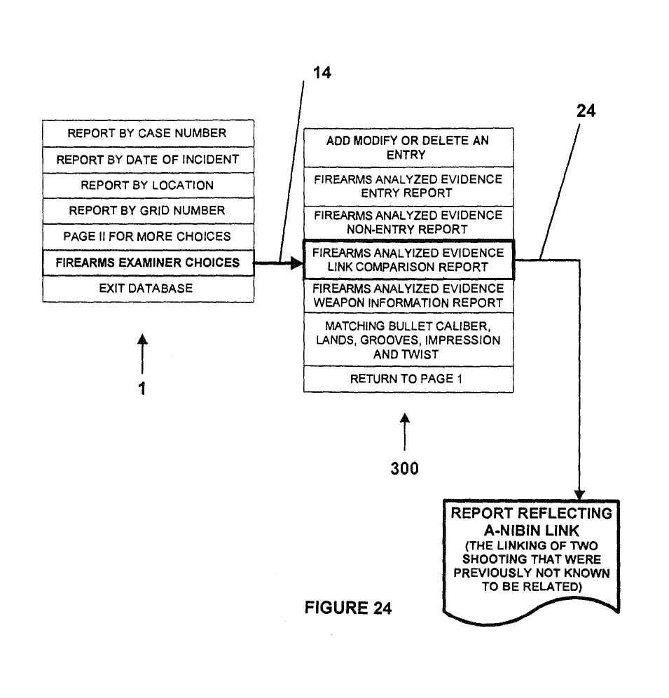

As shown in FIG. 24, step 24 will generate a firearms analyzed evidence link comparison report and FIG. 24A is an illustrative sample of such a report.

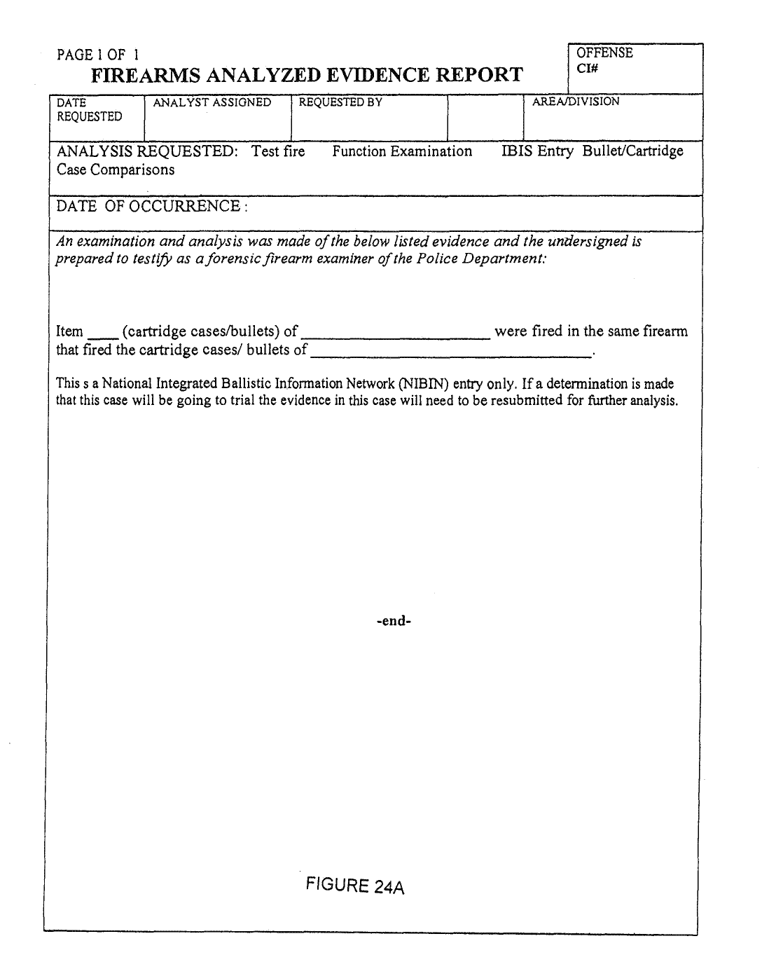

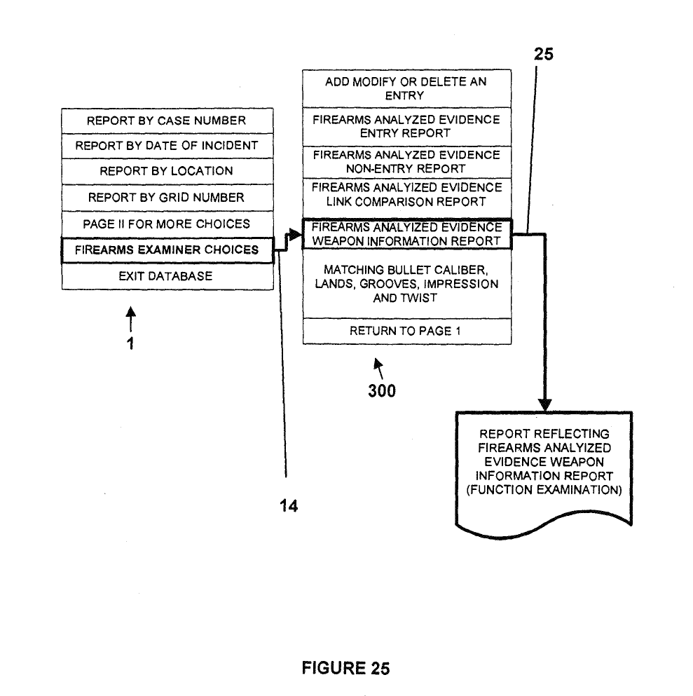

As shown in FIG. 25, step 25 will generate a firearms analyzed evidence weapon information report.

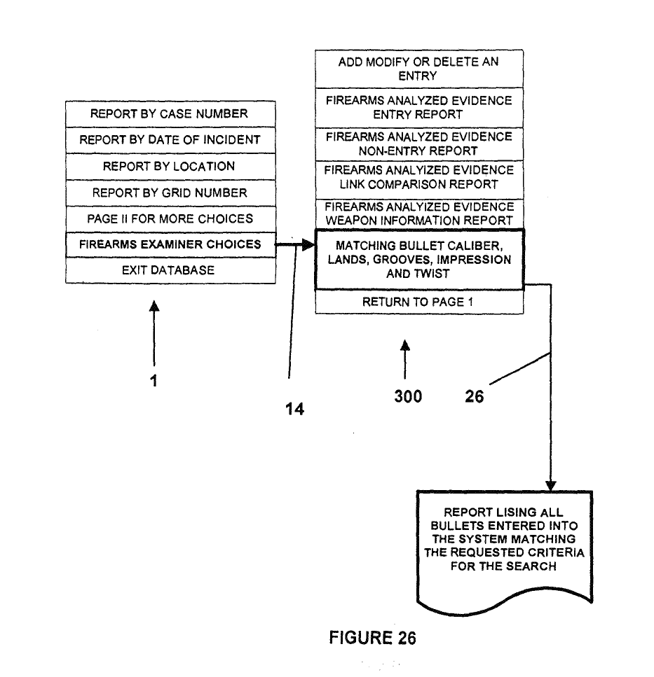

As shown in FIG. 26, step 26 will generate a matching bullet caliber, lands, grooves, impression and twist report.

Significantly, the time needed to generate any of the reports in steps 22-26 can be greatly simplified by using automatic report writing templates that pull required data needed for the report from the system database. This not only saves firearms examiner time, but also ensures accuracy of data since typographical errors are automatically eliminated.

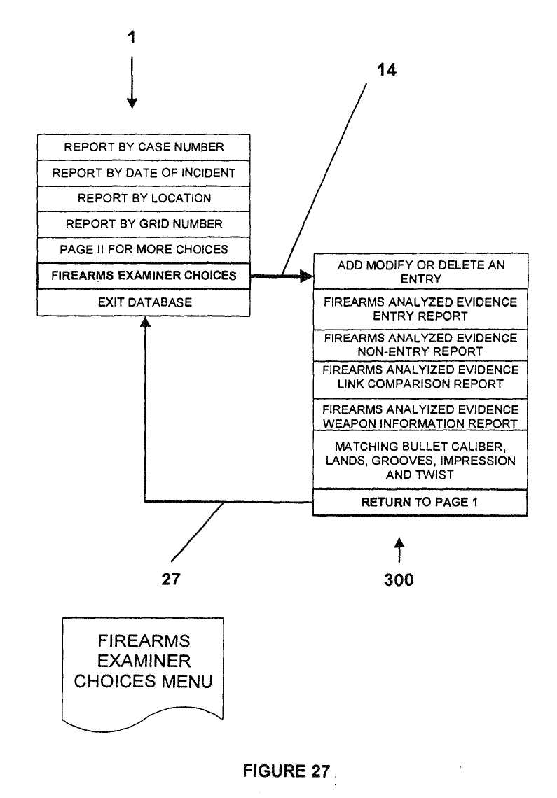

From page III (300 shown in FIG. 14), a permitted user can return to home page 100 (FIG. 1) via step 27 as shown in FIG. 27.

FIG. 28 is a sample of a query map generated using the parameter of caliber via step 8 (see FIG. 8). The map shows a geographical mapping grid with five different incidents notes. As depicted by the map, evidence from the incidents with case numbers 05-01101, 05-11003 and 05-22343 have not yet been examined or submitted to the crime lab for examination, whereas evidence from the incidents with case numbers 05-32343 and 05-12345 have been examined or submitted to the crime lab for examination. The query map also visually identifies that all of these five incidents involved a shooting in which a .45 Auto Cartridge Case was recovered. Based upon this map, an investigating officer might pull 05-11003, 05-01101 and 05-22343 and request that they be entered into the N.I.B.I.N. system.

We have now described the Firearms Correlation Module which can work as a standalone product or be incorporated in a comprehensive program that also includes Gang Database Modules, which we will now describe. In the remainder of this application the Firearms Correlation Module will simply be referred to generally as 110 as shown in FIG. 29.

### III. The Gang Database Modules

The Gang Database Modules 111-119 and the Firearms Correlation Module 110 can be accessed from a main menu, such as is shown in FIG. 29, to an entire system level program.

Once an entry or modification has been made to a data field in an individual Gang Database Module, the same entry or modification should be made to all of the database modules containing the same data field. The database data fields of the individual Gang Database Modules may have certain functions associated with certain data fields, such as a purge option. Thus, for example, if data can not be maintained after a certain period of time (e.g., legal requirements may require certain data to be purged after a specified time unless additional events transpire), then such information will automatically be purged at the requisite time periods. Also although data information may be modified or purged, it is especially desirable that a permanent archival record of all such changes to the database be kept, even if the purged information is not otherwise available to regular users of the databases, to insure integrity of the databases. And although all of the Gang Database Modules might be viewed as subsets of a larger overall database, it is useful to have multiple Gang Database Modules that are tailored to certain types of entries and reoccurring data fields, as well as use restrictions, to make use more intuitive to multiple users and so as to simplify some of the reporting and search functions.

Before allowing access to any of the individual Gang Database Modules, a log in or authentication process is required so that appropriate clearance for level of data access and functionality (e.g., read only or data entry as well as level of data entry allowability) is assured, and this process may be combined with requirements for access to the Firearms Correlation Module. During this process, certain users may be required to proceed through additional steps, such as triggering a use policy with an accept or decline requirement or legal notice requirements are acknowledged before allowing the user to proceed. It is desirable that there be an audit record which tracks what a given user accesses and views, the dates of searches, data entries and deletions made, etc.

For each Gang Database Module, once the module of interest is selected, the user is presented with the option of either adding/modifying data contained within the various data fields for the given module (assuming appropriate level of clearance) or performing a search of the database.

A search query function allows the user to either select previously identified common search parameters or perform a custom search by choosing what data fields should be searched and whether any search logic (e.g., Boolean search logic modifiers) should be applied. After the search has been performed, the user can choose one of three options (or change between these three options). The first option is to provide a report for each incident identified by the search. When the user chooses this option, all of the relevant data contained in all of the data fields for the incident is made available for review. The second option is to provide a list of incidents with each incident having a synopsis of relevant data field entries (and a link to go to the full report for a chosen incident, if that is desired). The synopsis can be custom generated based upon user selection or it can rely upon previously identified common synopsis entries. The third option is to map the incidents identified by the search. The mapping option will plot the incidents on a geographic grid with each incident being represented by a unique icon that is related to the class of crime or type of incident identified (e.g., a specific icon might be used to represent all incidents involving a homicide while a second specific icon might be used to represent all incidents involving a drive-by shooting not involving a homicide). When one specific unique icon from the mapped grid is subsequently chosen for further review, additional data will then be displayed for the incident, and the user can also then choose to pull up a synopsis for the incident or the entire report for the incident.

Within the search query function for a chosen Gang Database Module it may also be desirable to include one additional search option—a global database search option. When this option is chosen, the search field can be expanded to include all data fields from either one or more additional Gang Database Modules, or all of the Gang Database Modules (collectively the Gang Database), and possibly also the firearms correlation module. Using this option may also allow the user to transfer to other Gang Database Modules directly for further searching (assuming the user has requisite access rights to such modules).

It is also preferable that each Gang Database Module has its own automated report writing options that are either generalized or customized to individual needs typical of users of such modules or a particular organization and their reporting requirements, in much the same fashion as the Firearms Correlation Module provides its own automatic report writing capabilities.

We will now turn to a description of the reasons for each of the Gang Database Modules and the data fields contained with each of said Gang Database Modules.

The Gang Investigations Management Module 111 is designed to give the gang detective supervisor and other detectives the ability to track current and previously assigned gang-related cases within the Gang Unit. This is an important tool that assists the detective by giving the detective the ability to immediately recall any gang case, without having to use traditional law enforcement related search techniques that are often timely and require utilizing several different databases to get the needed information. This database streamlines this process, giving the gang detective case information in a timely, informative manner. The following data fields are included in this module: Case number—(preferably shown in the computer display in red font); Crime Type (e.g., CPC 245(a)(2)); Date Occurred; Time Occurred; Month Occurred; Location Occurred—(Street address); Grid—(City assigned geographic grid number, or police reporting district); Victim Gang—(Gang name, if known); Weapon(s) Used—(Detailed description of weapon used in the assault); Suspect Gang—(Gang Name, if Known); Suspect Vehicle(s) Involved—(Detailed description of suspect vehicles, if any); Circumstances—(Detailed description of the incident); Detective Assigned (Detective's name); and Case Status?—(I.e.—Open, Closed, Cleared by Arrest).

The Gang Information Tracking System (“G.I.T.S.”) 112 is designed to assist the gang investigative detail of any police agency with the task of tracking any and all gang-related or suspected gang-related incidents occurring within their jurisdiction and functions as a clearinghouse for all gang activity, downloaded automatically from department records management systems and dispatcher C.A.D. systems for use at a later time during subsequent investigations by gang investigators and other Investigations Bureau personnel. The detective is able to search the “G.I.T.S.” module for specific activity involving certain gang(s), gang members or incidents to assist them with a current investigation. Incidents include crime/arrests, crime/suspect, crime report only, gang-related information reports and all gang-related activity that does not generate an incident report, but is determined to be gang-related after evaluation by responding officers and/or other personnel involved (i.e. Dispatchers, Station Supervisors, Watch Commanders, etc.). This companion tool streamlines the gang investigative process and helps detectives develop leads for current gang-related investigations. It provides them with an easy-to-use process for extracting gang-related information from past incidents in a more timely and precise manner right from their desktop computer.

This in turn develops leads for current investigations that might otherwise go unidentified and unused by the detective. The following data fields are included in this module: Subject Number (An assigned number unique to the subject); Entry Case Number (Unique, department assigned incident number); Report Type (Crime Report, Crime Arrest, Information Report, etc.); Crime Type (Code Number for the actual crime incident, e.g.—CPC 187 for Murder in California); Day of Incident (Actual Day, i.e.—Monday through Sunday); Date of Incident (Actual date incident occurred, e.g.—May 21, 2006); Time of Incident (Military time incident occurred); Gang Involved (Name of suspect gang or gangs involved); Name of Officer Completing Report or Documenting Gang-related Incident; District (Unique policing district as determined by agency); Grid Number (Unique policing grid numbering system that divides the city up for better statistical analysis and patrolling functions); and Synopsis of Incident (Brief description of incident, i.e.—Who, What, When, Where, How and Why).

The Gang Homicide Module 113 is designed to assist the gang investigative detail of any police or law enforcement agency with the task of tracking all gang-related homicide incidents occurring within their jurisdiction and functions as an all purpose investigative tool to be used by detectives to track gang-related homicides, documenting all of the unique aspects of each case, providing an easy to read comprehensive report, while providing them with several search options at the touch of a button. The detective is able to search the module's data fields for specific information involving each homicide incident, including any suspect information available. This information is then used to assist them as they progress through their investigation and other homicide investigations that may be linked by suspect, weapon, victim or suspect gang, etc. This companion tool streamlines the gang homicide investigative process and helps detectives develop leads on current and past gang-related homicide investigations. It is also a great tool for any “Cold Case” homicide unit to use to easily locate specific information about cases that are several years old. The system provides detectives with an easy-to-use process for extracting information from past and current gang-related homicide investigations in a more timely and precise manner right from their desktop computer. The system also automatically tracks related incidents through a sophisticated GPS mapping system that uses the crime/incident location entered in the system to map each incident. The following data fields are included in this module: Case Number or Report Number (A department-assigned number unique to the incident); Cleared? (Identifies whether or not the case has been cleared); Year; Day; Date; Time; Grid Number (Policing district number where crime occurred); Location; Weapon Used; Suspect Vehicle; Victim Gang Affiliation (If applicable); Victim Last Name; Victim First Name; Victim Age; Suspect Gang Affiliation; Suspect Last Name; Suspect First Name; Suspect Age; Synopsis of Incident (Detailed narrative of incident with updates as they become available); Motive; Assigned Detective; and Case Book Location (Where case book is currently being kept, i.e.—detective's desk, specific shelf, etc.).

The Gang Arrest Module 114 is designed to give the gang detective the ability to track any and all arrests of documented gang members, associates and those individuals arrested during gang-related incidents. This is an important tool that assists the detective by giving a detective the ability to immediately recall any gang-related arrest, without having to use traditional law enforcement related search techniques that are often timely and require utilizing several different databases to get the needed information. This database streamlines the process, giving the gang detective basic arrest information in a timely, informative manner. The following data fields are included in this module: Month/Year of Arrest; Date; Last Name; First Name; Middle Name; Date of Birth; Case Number; Gang Involved; Charges; Detective/Officer Making Arrest; and Felony or Misdemeanor?.

The Gang Robbery Module 115 is designed to assist the gang investigative detail of any police or law enforcement agency with the task of tracking any and all gang-related or suspected gang-related robberies occurring within their jurisdiction functions as a clearinghouse for all gang-related robberies.

The information can either be downloaded manually by investigative personnel working the cases, or automatically from department records management systems and dispatcher C.A.D. systems. Detectives are able to search the data fields of this module for specific incidents to assist them during gang-related robbery investigations. Information tracked in the module includes all aspects of the crime, such as date, day and time of occurrence, location occurred, weapon(s) involved, suspect(s) description, vehicle description (if any) and more Incidents are determined to be gang-related after evaluation by responding officers and/or other personnel involved (i.e. Dispatchers, Station Supervisors, Watch Commanders, Detectives, etc.). This companion tool streamlines the gang-related robbery investigative process and helps detectives develop leads for current gang-related robbery investigations. It provides them with an easy-to-use process for extracting gang-related robbery information from past incidents in a more timely and precise manner right from their desktop computer. This in turn helps them develop leads for current investigations that might otherwise go unidentified and unused by the detective. The following data fields are included in this module: Month Occurred; Year Occurred; Case Number (Unique Department-Assigned Number for Each Incident); Date Occurred; Time Occurred; Day Occurred (Day of the Week Incident Occurred, i.e.—Wednesday); Location Occurred; Grid Number (Unique Policing District Grid Number Where Crime Occurred); Weapon(s) Involved; Suspect Gender; Suspect Race; Suspect Age; Suspect Height, Suspect Weight; Suspect Build; Suspect Hair Style; Suspect Complexion; Mustache (Yes/No and Brief Description); Oddities (Tattoos, etc.); Suspect Vehicle Year; Suspect Vehicle Make; Suspect Vehicle Model; Suspect Vehicle Color; Suspect Vehicle Doors (Two-Door, Four-Door); and Suspect Vehicle License Plate (Full or Partial).

The Gang Warrant Monitoring Module 116 is designed to assist the gang investigative detail of any police or law enforcement agency with the task of tracking any and all gang-related or suspected gang-related warrants active within their jurisdiction and functions as a tracking center for all gang-related warrant information. Warrant information is derived from agency cases after suspects have been identified and arrest warrants obtained following the department's policy and procedure and the District Attorney's warrant process. Once obtained, warrant information can be automatically or manually downloaded from the department's records management system, and/or other accessible warrant databases. Detectives and patrol personnel are able to search the module for warrant information based on suspect name, date of birth, address, CDL and SSN numbers, as well as several warrant specific identification numbers. This companion tool streamlines the investigative process and helps detectives and officers track both active and served warrant information. With this information, the detective/officer can chose a direction as to where they can better concentrate their efforts based on crime statistics, location, gang involvement and suspect information. The module provides them with an easy-to-use process for extracting gang-related warrant information in a timely manner right from their desktop computer. This in turn helps them concentrate their investigative efforts proactively, leading to long-term solutions for chronic problem locations, gangs and subjects. The following data fields are included in this module: Last Name; First Name; Middle Name; DOB; Address; Sex; Weight; Hair; Eyes; Oddity/Description; Addresses; Address Date; More Addresses; More Business Addresses; Vehicles; More Vehicles; OLN (Drivers License Number); SSN; CII (Criminal Index number for criminal rap sheet) FBI Number; Local Control Number; WFN (Warrant File Number) CWN (Court Warrant Number); Offense Date; Tracking Number; Issue Date; Case/Cite/Number; Assign Date; Count; Warrant Reason; Night Service Warrant Type; Release Condition; PSA; Degree; Bail Amount; Charges; Other Warrants?; More Charges; Key Number (unique number assigned to warrant to identify the warrant from all others); Date (the warrant issued); Police Department (that sought the warrant); Mailer (was something mailed out to the suspect); Other Names; Local Control No.; and Officer/Area.

The Gang Graffiti & Tagging Module 117 is designed to assist the gang investigative detail of any police or law enforcement agency with the task of tracking any and all graffiti-related or suspected graffiti-related incidents occurring within their jurisdiction and functions as an all purpose investigative tool to be used by detectives to track graffiti-related activity, identify the perpetrators and take them into custody, all while managing their caseloads and statistical data at the touch of a button. The detective is able to search the data fields of this module for specific information involving certain tagger/disruptive group graffiti activity, as well as gang-related graffiti incidents. This information is then used to assist them with their current investigations. Incidents tracked in the module include crime/arrest reports, crime/suspect reports, crime reports, tagger and gang-related activity information reports and all tagger and gang-related activity that may not generate an incident report, but is determined to be tagger/gang graffiti-related. This usually occurs after an incident has been evaluated by the investigating officer(s) and/or other personnel involved (i.e. Dispatchers, Station Supervisors, Watch Commanders or Detectives). This companion tool streamlines the graffiti vandalism investigative process and helps detectives develop leads on current and past graffiti-related investigations. The system provides detectives with an easy-to-use process for extracting graffiti-related information from past and current investigations in a more timely and precise manner right from their desktop computer. The system also automatically tracks related incidents through a sophisticated GPS mapping system that uses the crime/incident location entered in the system to map each incident. This in turn helps detectives develop leads during current investigations by linking previous graffiti-related incidents to current ones that might otherwise go unidentified and unused by the detective. The following data fields are included in this module: Case Number (A department-assigned number unique to the incident); Month; Year; Arrested by; Crime Type; Date Reported; Time Occurred; Victim; Damage; Location of Occurrence; Tagger Crew or Gang; Monikers Written; Arrestee/Suspect Last Name (×3); Arrestee/Suspect First Name (×3); Arrestee DOB (×3); and Remarks (Comments about the incident).

The Gang Injunction Module 118 is designed to assist the gang investigative detail of any police or law enforcement agency with the task of identifying, tracking and eventually serving individual gang members during the gang injunction process. The gang injunction process is a civil process that is very involved and requires that gang detectives identify gang members from a selected gang, track these identified gang members' criminal activity, and track gang related activities involving the selected gang throughout the process, This companion tool streamlines the gang injunction process, helping detectives justify their injunction, meet crucial deadlines determined by the court and complete the process successfully. The following data fields are included in this module for a given subject: Subject Number (An assigned number unique to the subject); Gender; Last Name; First Name; Date of Birth; Moniker; Street Address; City; Gang Affiliation; Tattoos; Preliminary Gang Injunction Served? (Checkbox); Permanent Gang Injunction Served? (Checkbox). The following fields are included in this module for a given Subject Incident Incident ID Number (A unique number assigned to each subject incident); Subject Number (An assigned number unique to the subject); Date of Incident; Time of Incident; Type of Incident (Dropdown box includes the following categories: “Arrest,” “Crime/Suspect,” “Cite,” “Detained,” Victim” and “Other”); Location (Where incident occurred); Case Number, If Any (Unique number assigned by the department to identify the incident); Cite Number; Gang Notice Served? (Checkbox) (Notice of Determination that the subject has been identified as an active participant in the gang); (Field Interview Report documenting contact); Subject's Photo (OLE Object Frame used to insert the subject's photo taken during contact); Comments (Used to describe the circumstances of the contact; and Officer's Name and Badge Number (Contact officer's information).

The Gang Case Filing (D.A.) Module 119 is designed to give the Gang Investigations Section and the District Attorneys Office the ability to track gang-related arrest cases to determine the status of each case as it progresses through the multi-phase process from the arrest through prosecution. This is an important tool that assists the detective and the assigned deputy district attorney by giving them the ability to immediately track any gang arrest case to determine where both agency's are in the prosecution process, whether or not there is sufficient background to support the gang allegations, who the assigned gang expert is and if the gang background has been completed and turned over to the assigned deputy district attorney. This database module then tracks the case as it progresses through the court process, concluding with the conviction status and sentence handed down by the court. This database module streamlines this process by giving the gang detective and deputy district attorney updated, current case information in a timely, informative manner. The following data fields are included in this module: Year—(preferably shown in the computer display in red font); Date Arrest Occurred; Report Case Number; Court Case Number; Defendant's Last Name; Defendant's First Name; Defendant's Date of Birth; Gang Involved; Co-Defendant?; Primary Arrest Charges; Date Arrest Report Received by Gangs; Date Reviewed by Gang Sergeant or Designate; Reviewed By; Preliminary Review and Background Confirms Active Gang, Active Participant and/or for Benefit of Gang (Includes a dropdown list that includes the following choices, “Yes,” “No” or “Undetermined”); Date Received by Gang Liaison Coordinator; Date Reviewed by Gang Liaison Coordinator; Additional Background Check Confirms Active Gang, Active Participant and/or for the Benefit of the Gang (Includes a dropdown list that includes the following choices, “Yes,” “No” or “Undetermined”); Case Accepted for Gang Charges? (Includes a dropdown list that includes the following choices, “Yes,” “No” or “Pending Further Examination”)—If Yes, then: Gang Expert Handling Case, Experts Contact Phone Number, Date Expert Confirmed, Date Background Package Completed and Turned Over to D.D.A., D.D.A. Assigned Case (If Any), or Contact Person at D.A.'s Office, Date D.D.A. was Advised on Disposition of Case—If No Reason Case was Rejected; Disposition of Case; Verdict?; Sentence Received Case Status (Includes a dropdown list that includes the following choices, “Open” or “Closed”); and Date Closed.

Having now described nine Gang Database Modules 111-119, the following is an illustrative example of how an overall system according to the present invention can be used to assist Firearms Examiners, Gang Detectives and others to efficiently and effectively investigate gang-related crimes where firearms have been used.

On Nov. 4, 2006 a gang-related shooting occurs at 100 S. Main Street. Citizens call in the crime to police dispatch, which then enter the information into the C.A.D. (Computer Aided Dispatch) System. As the incident is entered and identified as gang-related based on the initial call information, several pieces of information are automatically downloaded into the database including the date, time, location, a brief synopsis of incident as entered by the dispatcher and the case number assigned to the crime incident.

Officers arrive at the crime scene and develop additional information that will be transmitted to police dispatch and documented in their crime reports. Crime Scene Investigation (CSI) arrives and conducts their investigation. They collect several spent .45 caliber shell-casings at the shoot scene. When the initial investigation is concluded and the crime scene is dismantled, C.S.I. personnel return to the station to enter the firearms-related evidence (.45 casings) into the I.B.I.S.™ (Integrated Ballistics Information System) System and update the Firearms Correlation Module.

The database automatically maps the new incident and identifies it with a certain symbol and color so the Firearms Examiner and Gang Unit supervisor can easily identify new incidents in the database when they next review it.

The Gang Unit supervisor identifies the new shooting and reviews all information in the Gang Database to update his/her knowledge of the incident. The supervisor then obtains all crime reports, supplemental reports and C.S.I. reports to further investigate the crime. The supervisor then assigns the criminal investigation to one of his/her detectives. This information is entered into the Gang Investigations Management Module 111 that includes all of the basic facts of the crime and who the assigned detective is.

The assigned detective receives the case and begins an initial investigation. This includes reviewing the entire contents of all reports related to the crime, background on the victim, witnesses, possible suspects, vehicle information and ballistics (i.e. “Firearms Correlation Module”). As the investigation moves forward the Firearms Examiner links the evidence (Shell-Casings) to several other shooting incidents that have occurred over the past 12 months and that the suspect pistol is manufactured by the Smith and Wesson Firearms Corporation. Armed with this information, the Gang Database identifies that there is a detective assigned to the most recent case, so the Gang Database automatically forwards an e-mail to the assigned detective that his or her case has linked to additional shooting cases.

The detective enters the Gang Database and searches the case using the automated mapping system that uses GPS technology to accurately map the location of the incident, identifying it with a small picture of shell-casings and a specified color to indicate that the case has been entered into IBIS and linked to additional incidents. Upon holding the cursor over the crime incident on the map, the detective sees a synopsis of information related to his crime, including a listing of the gang-related shooting incidents that linked to the firearms used in this crime. The detective clicks on any one of the case numbers and it hyperlinks to the crime information related to that number.

The detective reviews all of the linked case numbers and is able to determine that the same firearm was used in a 2004 gang-related shooting homicide that is still unsolved with few leads and not currently being worked, two robbery incidents where the suspect shot the victims in the leg for unknown reasons, several shooting incidents with nothing more than shell-casings recovered by responding officers who documented the incident on an information report and booked the shell-casings as evidence to be entered into the appropriate systems. The detective also learns that the suspect firearm was used during a gang-related graffiti incident where “Gang-X” was caught by “Gang-Y” crossing out “Gang-Y′s” graffiti in their territory and shots were fired during the altercation. A moniker (nickname) is also left on the wall and is identified as “Gatto.”

Next, the detective opens each of the Gang Database Modules to develop additional information about these related crimes. Starting with the Gang Robbery Module 115 (the Detective's choice as to which module is reviewed first, second, third, etc.) the Detective reviews the information documenting the two correlated robbery incidents and contacts the assigned robbery detective who has been assigned the cases to let that detective know what information he/she has developed. Next the Detective opens Gang Information Tracking System 112 and reviews the several shots fired incidents information. Then the Detective reviews the Gang Homicide Module 113 to determine the circumstances surrounding this crime and passes this information on to the homicide detective who is assigned as the case agent. Finally, the Detective reviews Gang Graffiti & Tagging Module 117 and narrows down the gangs related to the shooting incidents as “Gang-X” or “Gang-Y.”

The Detective now searches the Gang Arrest Module 114 for any past arrests where the arrestee was from “Gang-X” and used a moniker of “Gatto.” The Detective identifies John J. Smith with an AKA: of “Gatto” who has also been contacted or documented as an active participant with “Gang-X.” The Detective also notes that Smith was arrested in 2003 for possession of a firearm. The Detective conducts follow up and learns that John J. Smith was out of custody during all of the related shooting incidents. The Detective also learns that John J. Smith has a girlfriend who drives a small blue pick-up truck that Smith often uses and has been contacted in on two occasions. A blue pick-up is the suspect vehicle used in the most recent gang-related shooting crime The Detective is currently investigating.

The Detective checks John J. Smith through probation and parole finds that he is on gang-terms probation for the 2003 possession of firearm arrest. With this information the Detective plans and executes an early morning probation search at Smith's residence. During the search, a .45 caliber Smith and Wesson pistol is located between Smith's mattresses. Smith is arrested for the applicable charges and brought to the station for interrogation about possession of the pistol and the associated crimes that have occurred during the 12-month period.

The Detective completes a photo line up with Smith in the line-up and re-contacts the victim and witnesses to the current shooting and gets a positive I.D. by the victim and one other witness. With this evidence, the Detective contacts the Deputy District Attorney who agrees that there is sufficient evidence to charge Smith with the recent shooting. The Detective interviews Smith about the crime and Smith denies any involvement. The Detective will follow up with Smith's girlfriend regarding the truck and whether or not she admits Smith had the vehicle at the time of the most recent shooting.

Next, the homicide detective interviews Smith about the gang-related shooting homicide from 2004. Smith eventually puts himself at the scene of the shooting, but denies any direct involvement. This coupled with other evidence and information developed during the revived investigation will be used by the homicide detective to support his case against Smith. Investigative continues.

The Detective books Smith on the Assault with a Deadly Weapon charges and continues his/her investigation into the other shooting crimes.

The Detective is unable to link Smith to the shots fired incidents where shell-casings were recovered, so the Detective puts these cases aside for now until the Detective re-interviews Smith about them at a later date.

The Detective contacts the robbery detective who is assigned the two robbery/shooting incidents and together they contact the two victims the Detective located in Gang Robbery Module 115. One of the two victims identifies Smith as the suspect who robbed and shot him in the leg in January 2006. The robbery detective takes this case to the Deputy District Attorney and he agrees that there is sufficient evidence to show Smith was the suspect in his case and agrees to file the robbery and ADW charges against Smith.

Armed with this evidence, the Detective and the robbery detective re-interview Smith about the robbery shooting crimes. Smith puts himself at both of the crimes, but claims it was someone else who committed the robbery/shooting as he stood by. He will not give up his accomplice.

As one can see, the Gang Database and accompanying Gang Database Modules played a key role in the timely transfer of important information that was acquired by the gang detective with ease in a timely manner. This led to the clearing by arrest of the ADW-firearm case that was originally assigned to the Detective, and one possibly two robbery/shooting cases, as well as opening up a cold case gang-related shooting homicide that had few leads and had not been work for more than a year.

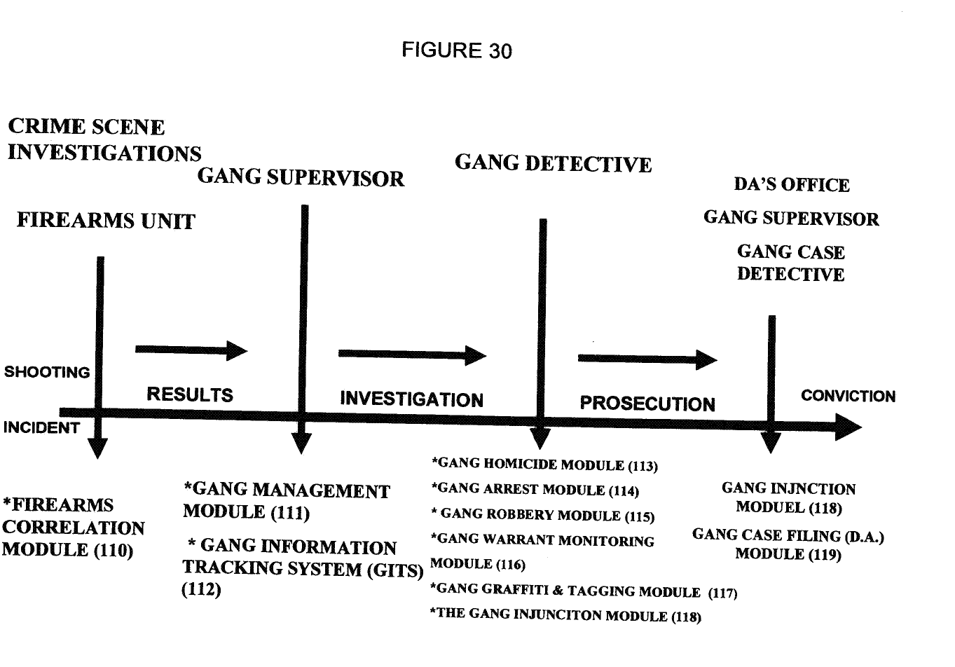

FIG. 30 conceptually illustrates how the Firearms Correlation Module and the various Gang Database Modules work together with existing database technology (the National Integrated Ballistic Identification Network) and various law enforcement personnel through the entire process from an initial investigation of an incident through prosecution and conviction of criminal offenders as a result of information obtained related to a firearms incident and gang related activity.

While the invention has been described herein with reference to a prototype embodiment of the present invention, especially as to the Firearms Correlation Module 110, this description has been presented by way of example only, and not to limit the scope of the invention. Additional embodiments thereof will be obvious to those skilled in the art having the benefit of this detailed description. Further modifications are also possible in alternative embodiments without departing from the inventive concept. In this regard, as technology marches forward, and both communications and computer equipment become faster, more efficient and cheaper, the present invention could easily be adapted to such changes. For example, it would be highly desirable to allow for easier collection and display of information in accordance with the present invention. Thus, GPS capabilities with a laptop connected to the mapping program and database will enable officers to see what has been occurring in their patrol area. Additional capabilities would enable officers to use devices such as a hand held that would enable them to stand at a crime scene, enter basic data regarding the scene and then send a wireless message to the program. This would enable automatic mapping with the basic information thus alerting lab personnel, supervisors and management of the crime scene. Further adaptability of the system also can cover such things as graffiti occurrences as well as managing latent print cases within the laboratory. As another example, much of the data input and data selection might be accomplished via a touch screen display, and mapping data might be displayed automatically on a visual display or a dedicated display device tasked for such a purpose. In addition, multiple improvements and enhancements can be made to the concepts and systems described herein. For example, especially in connection with the Gang Database Modules, individual user selection can be used to create priority patterns and put flags in the system to automatically alert the user, or other users, when certain type of data is entered into the Gang Database. Moreover, the Gang Database can be programmed in such a way that any changes to certain data fields will automatically trigger alerts to certain users, or prompt certain searches, and intelligent algorithms regarding linked connections of data fields can be used to further simplify searching and alerts regarding new information and links.

Accordingly, it will be apparent to those skilled in the art that still further changes and modifications in the actual concepts described herein can readily be made without departing from the spirit and scope of the disclosed inventions as defined by the following claims.

What is claimed is:

1: A process for targeted prioritization of investigating links related to firearms evidence, comprising:
using a computer to access a system database and display a map in which each of a plurality of firearms events is represented on the map by a symbol and the location of each such symbol is determined by a mapping grid corresponding to a firearms event associated with said each such symbol that is stored in the system database;
using the computer to generate a query request to correlate data from the system database based upon a chosen matching criteria that can be varied by an authorized user making the query request and generating a query report containing at least one correlation between a first selected event and a second selected event contained in the plurality of firearms events, and
requesting a possible link analysis between the first selected event and the second selected event;
wherein the possible link analysis seeks to establish a positive link between a first piece of firearms evidence associated with the first selected event and a second piece of firearms evidence associated with the second selected event and said link analysis is based at least in part upon a visual comparison between the first and the second pieces of firearms evidence;
wherein the plurality of event data and a plurality of firearms information data for the plurality of firearms events are stored in the system database; and
wherein the chosen matching criteria is one of the plurality of firearms information data.

2: The process of claim 1, wherein the map contains a street overlay.

3: The process of claim 2, wherein the chosen matching criteria is one of a plurality of class characteristics of the plurality of firearms information data.

4: The process of claim 3, wherein the plurality of class characteristics is comprised of a weapon data entry and a bullet data entry.

5: The process of claim 4, wherein the weapon data entry is further comprised of a land and grooves entry, a direction of twist entry, a lands measurement and a grooves measurement.

6: The process of claim 5, wherein the bullet data entry data is further comprised of whether a cartridge case has a circular firing pin or an elliptical firing pin and an arched breech face, a parallel breech face, a cross hatch breech face, a smooth breech face or a granular breech face.

7: The process of claim 6, further comprising:
electronically displaying a query map that is populated with a plurality of symbols associated with a plurality of correlated firearms events identified in the query report.

8: The process of claim 1, further comprising:
electronically displaying a query map that is populated with a plurality of symbols associated with a plurality of correlated firearms events identified in the query report.

9: The process of claim 8, further comprising:
using the computer to generate a second query request that correlates data from the system database based upon a second chosen matching criteria associated with at least one of the plurality of correlated firearms events and generating a second query report identifying any found correlation between the at least one of the plurality of correlated firearms events and the plurality of firearms events.

10: The process of claim 9, further comprising:
electronically displaying a second query map that is populated with a second plurality of symbols associated with a second plurality of correlated firearms events identified in the second query report.

11: The process of claim 10, wherein the symbol is comprised of a display that contains an indication of whether an entry regarding the firearms event associated with said symbol has been entered into an imaged based computer network.

12: The process of claim 2, wherein the symbol is comprised of a display that contains an indication of whether an entry regarding the firearms event associated with said symbol has been entered into an imaged based computer network.

13: The process of claim 12, wherein the possible link analysis is based at least in part upon making at least one entry regarding at least one of the first and second pieces of firearms evidence into the imaged based computer network.

14: The process of claim 13, wherein the symbol includes an icon associated with the type of evidence associated with said symbol.

15: The process of claim 12, wherein the system database contains a record of any positive links of different firearms evidence and the symbol associated with any of the plurality of firearms events for which any such positive link is established contains a visual indicator of said such positive link.

16: The process of claim 2, wherein the system database contains a record of any positive links of different firearms evidence and the symbol associated with any of the plurality of firearms events for which any such positive link is established contains a visual indicator of said such positive link.

17: The process of claim 1, wherein the system database is periodically updated with at least one new firearms event that is added to plurality of firearms events and then the map is updated to display a new symbol associated with the at least one new firearms event.

18: The process of claim 1, further comprising:
using the computer to prepare a report related to the possible link analysis through use of an automatic report writing program that pulls required data needed from the report from the system database.
